(19) United States
(12) Patent Application Publication
(10) Pub. No.: US 2025/0371349 A1
(43) Pub. Date: Dec. 4, 2025

(54) METHODS AND APPARATUS FOR HARDWARE-AWARE MACHINE LEARNING MODEL TRAINING

(71) Applicant: Intel Corporation, Santa Clara, CA (US)

(72) Inventors: Xiaofan Xu, Dublin 11 (IE); Cormac Brick, San Francisco, CA (US); Zsolt Biro, Com Zetea (RO)

(73) Assignee: Intel Corporation, Santa Clara, CA (US)

(21) Appl. No.: 19/306,117

(22) Filed: Aug. 21, 2025

Related U.S. Application Data
(63) Continuation of application No. 17/013,258, filed on Sep. 4, 2020.

(51) Int. Cl. G06N 3/08; G06F 1/10; G06F 9/30; G06F 9/38; G06N 3/04

(52) U.S. Cl. CPC G06N 3/08; G06F 1/10; G06F 9/30036; G06F 9/3877; G06N 3/04

(57) ABSTRACT

Methods, apparatus, systems, and articles of manufacture are disclosed for hardware-aware machine learning model training. An example apparatus includes a configuration determiner to determine a hardware configuration of a target hardware platform on which the machine learning model is to be executed, a layer generator to assign sparsity configurations to layers of the machine learning model based on the hardware configuration, and a deployment controller to deploy the machine learning model to the target hardware platform in response to outputs of the machine learning model satisfying respective thresholds, the outputs including a quantity of clock cycles to execute the machine learning model with the layers having the assigned sparsity configurations.

### CROSS-REFERENCE TO RELATED APPLICATION

This application is a continuation of (and claims the benefit of priority to) U.S. patent application Ser. No. 17/013,258, filed Sep. 4, 2020, titled, “METHODS AND APPARATUS FOR HARDWARE-AWARE MACHINE LEARNING MODEL TRAINING,” which is incorporated by reference in its entirety for all purposes.

### FIELD OF THE DISCLOSURE

This disclosure relates generally to artificial intelligence and, more particularly, to methods and apparatus for hardware-aware machine learning model training.

### BACKGROUND

Machine learning models, such as neural networks, are useful tools that have demonstrated their value solving complex problems regarding pattern recognition, natural language processing, automatic speech recognition, etc. Neural networks operate, for example, using artificial neurons arranged into layers that process data from an input layer to an output layer, applying weighting values to the data during the processing of the data. Such weighting values are determined during a training process.

### BRIEF DESCRIPTION OF THE DRAWINGS

FIG. 1 is a schematic illustration of an example computing system including an example model training controller.

FIG. 2 is a block diagram of an example implementation of the example model training controller of FIG. 1.

FIG. 3 is a block diagram of the example model training controller of FIGS. 1 and/or 2 to train a machine learning model.

FIG. 4 is another block diagram of the example model training controller of FIGS. 1 and/or 2 to train a machine learning model.

FIG. 5 is yet another block diagram of the example model training controller of FIGS. 1 and/or 2 to train a machine learning model.

FIG. 6A depicts a first table of first example output data from a first example machine learning model trained by the example model training controller of FIGS. 1 and/or 2.

FIG. 6B depicts a second table of second example output data from the first example machine learning model not trained by the example model training controller of FIGS. 1 and/or 2.

FIG. 7A depicts a third table of third example output data from a second example machine learning model trained by the example model training controller of FIGS. 1 and/or 2.

FIG. 7B depicts a fourth table of fourth example output data from the second example machine learning model not trained by the example model training controller of FIGS. 1 and/or 2.

FIG. 8A depicts a fifth table of fifth example output data from a third example machine learning model trained by the example model training controller of FIGS. 1 and/or 2.

FIG. 8B depicts a sixth table of sixth example output data from the third example machine learning model not trained by the example model training controller of FIGS. 1 and/or 2.

FIG. 9A is a first example graph based on the first example output data of FIG. 6A and the second example output data of FIG. 6B.

FIG. 9B is a second example graph based on the third example output data of FIG. 7A and the fourth example output data of FIG. 7B.

FIG. 9C is a third example graph based on the fifth example output data of FIG. 8A and the sixth example output data of FIG. 8B.

FIG. 10A is a first graph of example activation sparsity percentages with respect to example layer indices.

FIG. 10B is a second graph of example sparsity percentages with respect to example layer indices for an example machine learning model trained by the example model training controller of FIGS. 1 and/or 2.

FIG. 10C is a third graph of example sparsity percentages with respect to example layer indices for an example machine learning model not trained by the example model training controller of FIGS. 1 and/or 2.

FIG. 11 depicts an example hardware configuration that may be used by the example model training controller of FIGS. 1 and/or 2 to train an example machine learning model.

FIG. 12 is a flowchart representative of example machine readable instructions that may be executed to implement the example model training controller of FIGS. 1 and/or 2 to train a machine learning model based on a configuration of a target hardware platform.

FIG. 13 is another flowchart representative of example machine readable instructions that may be executed to implement the example model training controller of FIGS. 1 and/or 2 to train a machine learning model based on a configuration of a target hardware platform.

FIG. 14 is a block diagram of an example processing platform structured to execute the example machine readable instructions of FIGS. 12 and/or 13 to implement the example model training controller of FIGS. 1 and/or 2.

FIG. 15 is a block diagram of an example software distribution platform to distribute software (e.g., software corresponding to the example machine readable instructions of FIGS. 12 and/or 13) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

### DETAILED DESCRIPTION

The figures are not to scale. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a neural network (e.g., a convolution neural network, a deep neural network, a graph neural network, etc.) model is used. In general, machine learning models/architectures that are suitable to use in the example approaches disclosed herein include convolution neural networks. However, other types of machine learning models could additionally or alternatively be used such as artificial neural networks, two-layer (2-layer) radial basis neural networks (RBN), learning vector quantization (LVQ) classification neural networks, etc.

In general, implementing a ML/AI system involves at least two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, reinforcement learning includes a machine, an agent, etc., interacting with its environment, performing actions, and learning by a trial-and-error technique. In other examples, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using reinforcement learning. However, any other training algorithm may additionally or alternatively be used. In some examples disclosed herein, training is performed until the level of error is no longer reducing and/or otherwise satisfies a threshold (e.g., an accuracy threshold, a training threshold, etc.). In some examples disclosed herein, training is performed until a number or quantity of cycles (e.g., clock cycles, instruction cycles, processor cycles, etc.) to execute a trained machine learning model or portion(s) thereof (e.g., one or more layers of the trained machine learning model) satisfies a threshold (e.g., a cycle threshold, a clock cycle threshold, an instruction cycle threshold, a processor cycle threshold, a training threshold, etc.). In examples disclosed herein, training can be performed locally on a computing system and/or remotely at an external computing system (e.g., a central facility, one or more servers, etc.) communicatively coupled to the computing system. Training is performed using hyperparameters that control how the learning is performed (e.g., a learning rate, a number of layers to be used in the machine learning model, etc.). In examples disclosed herein, hyperparameters that control model performance and training speed are the learning rate, a number of Epochs, a topology of the neural network, a size of the neural network, and/or regularization parameter(s). Such hyperparameters are selected by, for example, trial and error to reach an optimal model performance. In some examples re-training may be performed. Such re-training may be performed in response to override(s) by a user.

Training is performed using training data. In examples disclosed herein, the training data originates from a database (e.g., an open-source training data source, a publicly available training data source, an image database, etc.). In some examples disclosed herein, the training data is labeled when supervised training is used. Labeling is applied to the training data manually by a user or by an automated data pre-processing system. In some examples, the training data is sub-divided. For example, the training data can be sub-divided into a first portion of data for training the model and a second portion of data for validating the model. In other examples, the training data can be sub-divided into a first portion of data for training the model and a second portion of data for fine-tuning and/or otherwise adjusting the model after the model training.

Once training is complete, the model is deployed for use as an executable construct that processes an input and provides an output based on the network of nodes and connections defined in the model. The model is stored in memory of the computing system or in a database of a remote computing system. The model may then be executed by the computing system or a different computing system.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Embedded systems with limited computational power and memory bandwidth lack the hardware resources needed to accelerate the processing of neural networks to pursue state-of-the-art accuracy due to the increasing size of such neural networks. To reduce the size of neural networks, network compression techniques, such as sparsity techniques that exploit the concept of sparsity, may be used. Some of these network compression techniques are rule-based (e.g., rule-based network compression techniques). Such rule-based techniques cannot be generalized for all existing neural networks. For example, some rule-based techniques attempt to sparsify parameters less in early layers (e.g., layers that include useful information of the low-level features) and sparsify parameters more in later layers, or final fully connected layers (e.g., layers that include more parameters). Such rule-based techniques do not consider the dependency between the layers in the neural network and cannot easily transfer from one neural network architecture to another.

Under the current paradigm in machine learning, neural network models are trained using hardware-agnostic techniques. As a result, the building blocks (e.g., functions) and layers are not tuned to the architecture of a target hardware platform on which trained neural network models are to execute. This lack of tuning affects the performance of trained neural network models during the inference. For example, if a model was trained on a graphics processing unit (GPU), then when the model executes with non-GPU architectures (e.g., a vision processing unit (VPU)) and/or accelerators that do not necessarily optimally support GPU operators, the model will not perform at an equivalent level. In such examples, the model is not optimal on other accelerators. For example, a 7×7 depth-wise-separable convolution may perform acceptably on a GPU, but such an operation is typically far from optimal on most AI accelerators. In such examples, training the model without consideration of whether the model is to be executed on a target hardware platform of interest, such as a GPU or a different AI accelerator, can lead to varying degrees of accuracy and efficiency of model execution.

Further, hardware-agnostic machine learning training techniques do not take into consideration the hardware performance of a target hardware platform during sparsity generation when executing a network compression technique. Key target criteria for sparsity-based techniques include compression and speed-up. However, models generated by such sparsity-based techniques may have large overall sparsity but perform poorly (e.g., low speed-up) on a target hardware platform. For example, a neural network with large overall sparsity may have suboptimal model execution or performance on the target hardware platform due to architectural factors (e.g., processing, memory, and/or caching architecture factors).

Examples disclosed herein include hardware-aware machine learning model training of models, such as neural network models. In some disclosed examples, an example model training controller applies hardware-aware sparsity to a neural network based on an architecture (e.g., a hardware, software, and/or firmware architecture) of a target hardware platform or portion(s) thereof. In some disclosed examples, the model training controller effectuates reinforcement learning on a neural network to identify sparsity ratios for one or more layers of the neural network. In such disclosed examples, the model training controller identifies the sparsity ratios based on the architecture of the target hardware platform.

Advantageously, the example model training controller can train the neural network to achieve high performance on the target hardware platform with greater sparsity ratios relative to a baseline version of the neural network. Advantageously, the example model training controller can train different types of accelerators, such as a central processing unit (CPU), a GPU, a VPU, etc., with a subset of a training dataset to improve a speed at which to train a neural network and an efficiency of utilizing hardware resources to train the neural network.

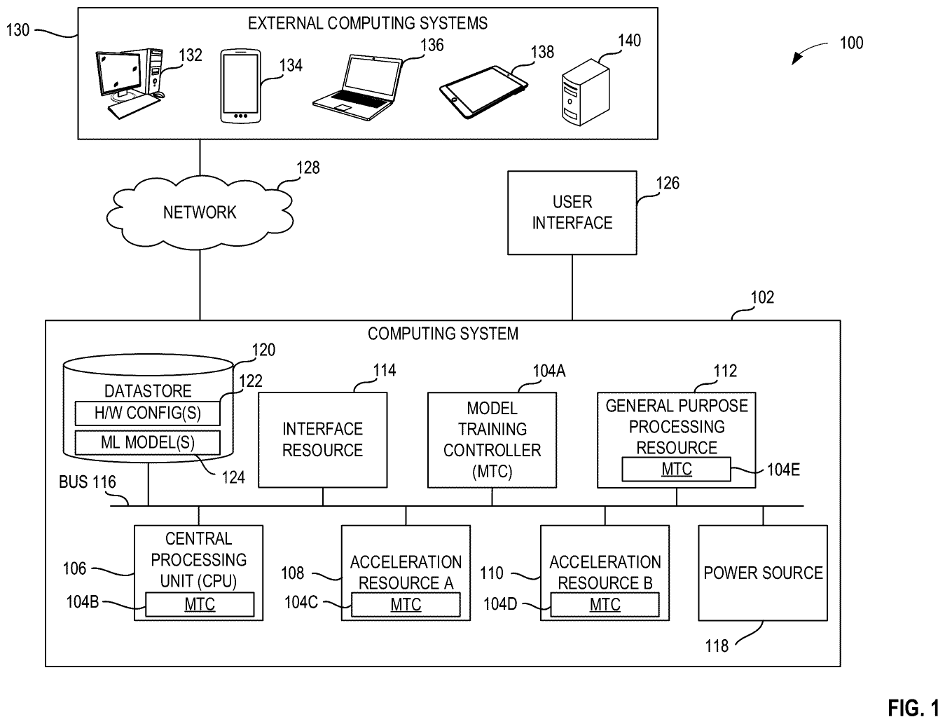

FIG. 1 is a schematic illustration of an example computing environment 100 including an example computing system 102 including an example model training controller 104A-E to effectuate a training and deployment of a machine learning model. The computing system 102 of the example of FIG. 1 includes an example central processing unit (CPU) 106, a first example acceleration resource (ACCELERATION RESOURCE A) 108, a second example acceleration resource (ACCELERATION RESOURCE B) 110, an example general purpose processing resource 112, an example interface resource 114, an example bus 116, an example power source 118, and an example datastore 120. The datastore 120 of the example of FIG. 1 includes example hardware configuration(s) (H/W CONFIG(S)) 122 and example machine learning model(s) (ML MODEL(S)) 124. Further depicted in the example of FIG. 1 is an example user interface 126, an example network 128, and example external computing system(s) 130.

In the illustrated example of FIG. 1, the computing system 102 is a computing device on which the machine learning model(s) 124 is/are to be executed. In some examples, the computing system 102 is a mobile device, such as a cell or mobile phone (e.g., an Internet-enabled smartphone), a tablet computer (e.g., an Internet-enabled tablet), etc. For example, the computing system 102 can be implemented as a mobile phone having one or more processors (e.g., a CPU, a GPU, a VPU, an AI or neural-network (NN) specific processor, etc.) on a single system-on-a-chip (SoC). In some examples, the computing system 102 is a desktop computer, a laptop computer, a server, etc. For example, the computing system 102 can be implemented as a desktop computer, a laptop computer, a server, etc., having one or more processors (e.g., a CPU, a GPU, a VPU, an AI/NN specific processor, etc.) on a single SoC.

In some examples, the computing system 102 is a system-on-a-chip (SoC) representative of one or more integrated circuits (ICs) (e.g., compact ICs) that incorporate components of a computer or other electronic system in a compact format. For example, the computing system 102 may be implemented with a combination of one or more programmable processors, hardware logic, and/or hardware peripherals and/or interfaces. Additionally or alternatively, the example computing system 102 of FIG. 1 may include memory, input/output (I/O) port(s), and/or secondary storage. For example, the computing system 102 includes the model training controller 104A-E, the CPU 106, the first acceleration resource 108, the second acceleration resource 110, the general purpose processing resource 112, the interface resource 114, the bus 116, the power source 118, the datastore 120, the memory, the I/O port(s), and/or the secondary storage all on the same substrate. In some examples, the computing system 102 includes digital, analog, mixed-signal, radio frequency (RF), or other signal processing functions.

In the illustrated example of FIG. 1, the first acceleration resource 108 is a graphics processing unit (GPU). For example, the first acceleration resource 108 is a GPU that generates computer graphics, executes general-purpose computing, etc. In some examples, the first acceleration resource 108 processes AI tasks. In such examples, the first acceleration resource 108 can execute and/or otherwise implement a neural network, such as an artificial neural network (ANN), a convolution neural network (CNN), a deep neural network (DNN), a recurrent neural network (RNN), etc.

The second acceleration resource 110 of the example of FIG. 1 is a vision processing unit (VPU). For example, the second acceleration resource 110 can effectuate machine or computer vision computing tasks. In such examples, the second acceleration resource 110 can execute and/or otherwise implement a neural network, such as an ANN, a CNN, a DNN, an RNN, etc.

The general purpose processing resource 112 of the example of FIG. 1 is a programmable processor, such as a CPU or a GPU. In some examples, the general purpose processing resource 112 completes AI tasks. In such examples, the general purpose processing resource 112 can execute and/or otherwise implement a neural network, such as an ANN, a CNN, a DNN, an RNN, etc.

In this example, the CPU 106, the first acceleration resource 108, the second acceleration resource 110, and the general purpose processing resource 112 are target hardware, or target hardware platforms. Alternatively, one or more of the first acceleration resource 108, the second acceleration resource 110, and/or the general purpose processing resource 112 may be a different type of hardware such as a digital signal processor (DSP), an application specific integrated circuit (ASIC), a programmable logic device (PLD), and/or a field programmable logic device (FPLD) (e.g., a field-programmable gate array (FPGA)).

In the illustrated example of FIG. 1, the interface resource 114 is representative of one or more interfaces. For example, the interface resource 114 may be implemented by a communication device (e.g., a network interface card (NIC), a smart NIC, etc.) such as a transmitter, a receiver, a transceiver, a modem, a residential gateway, a wireless access point, and/or a network interface to facilitate exchange of data with external machines (e.g., computing devices of any kind) via the network 128. In some examples, the communication is effectuated via an Ethernet connection, a digital subscriber line (DSL) connection, a telephone line connection, a coaxial cable system, a satellite system, a line-of-site wireless system, a cellular telephone system, etc. For example, the interface resource 114 may be implemented by any type of interface standard, such as a wireless fidelity (Wi-Fi) interface, an Ethernet interface, a universal serial bus (USB), a Bluetooth interface, a near field communication (NFC) interface, and/or a PCI express interface.

The computing system 102 includes the power source 118 to deliver power to resource(s) of the computing system 102. In the example of FIG. 1, the power source 118 is a battery. For example, the power source 118 is a limited-energy device, such as a lithium-ion battery or any other chargeable battery or power source. In such examples, the power source 118 is chargeable using a power adapter or converter (e.g., an alternating current (AC) to direct current (DC) power converter), a wall outlet (e.g., a 110V AC wall outlet, a 220V AC wall outlet, etc.), etc.

The computing system 102 of the example of FIG. 1 includes the datastore 120 to record data (e.g., the hardware configuration(s) 122, the machine learning model(s) 124, etc.). The datastore 120 of this example may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 120 may additionally or alternatively be implemented by one or more double data rate (DDR) memories, such as DDR, DDR2, DDR3, DDR4, mobile DDR (mDDR), etc. The datastore 120 may additionally or alternatively be implemented by one or more mass storage devices such as hard disk drive(s), compact disk (CD) drive(s), digital versatile disk (DVD) drive(s), solid-state disk drive(s), etc. While in the illustrated example the datastore 120 is illustrated as a single database, the datastore 120 may be implemented by any number and/or type(s) of databases. Furthermore, the data stored in the datastore 120 may be in any data format such as, for example, binary data, comma delimited data, tab delimited data, structured query language (SQL) structures, etc.

In the illustrated example of FIG. 1, the datastore 120, and/or, more generally, the computing system 102, stores the hardware configuration(s) 122 to be used as model input(s) for training one(s) of the machine learning model(s) 124. In this example, the hardware configuration(s) 122 include one or more hardware configurations for respective one(s) of the resource(s) of the computing system 102. For example, the hardware configuration(s) 122 can include a first hardware configuration associated with the CPU 106, a second hardware configuration associated with the first acceleration resource 108, a third hardware configuration associated with the second acceleration resource 110, a fourth hardware configuration associated with the general purpose processing resource 112, etc.

In the illustrated example of FIG. 1, the datastore 120, and/or, more generally, the computing system 102, stores the machine learning model(s) 124 to facilitate the training, deployment, and/or execution of the machine learning model(s) 124 on the computing system 102 and/or one(s) of the external computing system(s) 130. In this example, the machine learning model(s) 124 include one or more machine learning models. For example, the machine learning model(s) 124 can include a first neural network model, a second neural network model, etc. In such examples, the first neural network model can be a baseline neural network model, such as a neural network model that has been trained with a conventional machine learning training technique. In some such examples, the second neural network model can be a neural network model trained by the model training controller 104A-E, which trains the neural network model based on the hardware configuration(s) 122 that corresponds to a target hardware platform (e.g., the CPU 106, the first acceleration resource 108, etc.) on which to execute the neural network model.

In the illustrated example of FIG. 1, the computing system 102 is in communication with the user interface 126. For example, the user interface 126 is a graphical user interface (GUI), an application display, etc., presented to a user on a display device in circuit with and/or otherwise in communication with the computing system 102. In such examples, a user controls the computing system 102, adjusts a machine learning training parameter (e.g., a learning rate, a number of layers to be used in the machine learning model, etc.) to train the machine learning model(s) 124, etc., via the user interface 126. Alternatively, the computing system 102 may include the user interface 126.

In the illustrated example of FIG. 1, the model training controller 104A-E, the CPU 106, the first acceleration resource 108, the second acceleration resource 110, the general purpose processing resource 112, the interface resource 114, the power source 118, and the datastore 120 are in communication with the bus 116. For example, the bus 116 corresponds to, is representative of, and/or otherwise includes at least one of an Inter-Integrated Circuit (I2C) bus, a Serial Peripheral Interface (SPI) bus, or a Peripheral Component Interconnect (PCI) bus.

The network 128 of the example of FIG. 1 is the Internet. However, the network 128 of this example may be implemented using any suitable wired and/or wireless network(s) including, for example, one or more data buses, one or more Local Area Networks (LANs), one or more wireless LANs, one or more cellular networks, one or more private networks, one or more public networks, etc. The network 128 enables the computing system 102 to be in communication with the external computing system(s) 130.

In the illustrated example of FIG. 1, the external computing systems 130 are computing devices on which the machine learning model(s) 124 is/are to be executed. In this example, the external computing systems 130 include an example desktop computer 132, an example mobile device (e.g., a smartphone, an Internet-enabled smartphone, etc.) 134, an example laptop computer 136, an example tablet (e.g., a tablet computer, an Internet-enabled tablet computer, etc.) 138, and an example server 140. In some examples, fewer or more computing systems than depicted in FIG. 1 may be used. Additionally or alternatively, the external computing systems 130 may include, correspond to, and/or otherwise be representative of any other type of computing device.

In some examples, one or more of the external computing systems 130 execute one(s) of the machine learning model(s) 124 to process a computing workload (e.g., an AI/ML workload). For example, the mobile device 134 can be implemented as a cell or mobile phone having one or more processors (e.g., a CPU, a GPU, a VPU, an AI or neural-network (NN) specific processor, etc.) on a single system-on-a-chip (SoC) to process an AI/ML workload using one(s) of the machine learning model(s) 124. For example, the desktop computer 132, the laptop computer 136, the tablet computer, and/or the server 140 can be implemented as computing device(s) having one or more processors (e.g., a CPU, a GPU, a VPU, an AI/NN specific processor, etc.) on one or more SoCs to process an AI/ML workload using one(s) of the machine learning model(s) 124. In some examples, the server 140 includes and/or otherwise is representative of one or more servers that can implement a central or data facility, a cloud service (e.g., a public or private cloud provider, a cloud-based repository, etc.), etc., to process AI/ML workload(s) using one(s) of the machine learning model(s) 124.

In the illustrated example of FIG. 1, the computing system 102 includes a first model training controller 104A (e.g., a first instance of the model training controller 104A-E), a second model training controller 104B (e.g., a second instance of the model training controller 104A-E), a third model training controller 104C (e.g., a third instance of the model training controller 104A-E), a fourth model training controller 104D (e.g., a fourth instance of the model training controller 104A-E), and a fifth model training controller 104E (e.g., a second instance of the model training controller 104A-E) (collectively referred to herein as the model training controller 104A-E unless specified otherwise herein). In the example of FIG. 1, the first model training controller 104A is implemented by hardware, software, and/or firmware. For example, the first model training controller 104A may be implemented by one or more analog or digital circuit(s), logic circuits, programmable processor(s), programmable controller(s), GPU(s), VPU(s), DSP(s), ASIC(s), PLD(s), and/or FPLD(s).

In the illustrated example of FIG. 1, the second model training controller 104B is implemented by the CPU 106, the third model training controller 104C is implemented by the first acceleration resource 108, the fourth model training controller 104D is implemented by the second acceleration resource 110, and the fifth model training controller 104E is implemented by the general purpose processing resource 112. Additionally or alternatively, the first model training controller 104A, the second model training controller 104B, the third model training controller 104C, the fourth model training controller 104D, the fifth model training controller 104E, and/or portion(s) thereof, may be virtualized, such as by being implemented using one or more virtual machines, one or more containers, etc. Additionally or alternatively, the first model training controller 104A, the second model training controller 104B, the third model training controller 104C, the fourth model training controller 104D, and/or the fifth model training controller 104E may be implemented by a different resource of the computing system 102, such as the first acceleration resource 108, the second acceleration resource 110, etc. Alternatively, the computing system 102 may not include the first model training controller 104A, the second model training controller 104B, the third model training controller 104C, the fourth model training controller 104D, the fifth model training controller 104E.

In example operation, the model training controller 104A-E trains one(s) of the machine learning model(s) 124 based on one(s) of the hardware configuration(s) 122. For example, the third model training controller 104C of the first acceleration resource 108 can retrieve a first one of the machine learning model(s) 124 from the datastore 120, the external computing system(s) 130 via the network 128, etc. In such examples, the third model training controller 104C can retrieve a first one of the hardware configuration(s) 122 that corresponds to the first acceleration resource 108. For example, the first one of the hardware configuration(s) 122 can include at least one of memory configuration information, caching configuration information, or processing configuration information associated with the first acceleration resource 108.

In example operation, the model training controller 104A-E assigns sparsity ratios to respective layers of the machine learning model(s) 124. For example, the third model training controller 104C can generate a first action including assigning a first sparsity ratio of 70% to a first level, a second action including assigning a second sparsity ratio of 65% to a second level, etc., of the first one of the machine learning model(s) 124. In such examples, the third model training controller 104C determines a quantity of cycles (e.g., clock cycles, instruction cycles, processor cycles, etc.) to execute the respective layers using the sparsity ratio assignments.

In example operation, responsive to the sparsity ratio assignments, the model training controller 104A-E executes the machine learning model(s) 124 using a training dataset or portion thereof. For example, the third model training controller 104C can execute the first one of the machine learning model(s) 124 to generate an output (e.g., a model output), such as a reward. In such examples, the reward can be an accuracy of the first one of the machine learning model(s) 124. In some such examples, the third model training controller 104C can generate a new set of one or more actions to adjust the sparsity ratios for respective layers of the first one of the machine learning model(s) 124 based on the reward (e.g., to maximize the reward).

In some examples, the model training controller 104A-E deploys the first one of the machine learning model(s) 124 responsive to the reward being maximized and/or otherwise satisfying a threshold, such as a reward threshold, a training threshold, etc. For example, the model training controller 104A-E can generate and/or otherwise compile the first one of the machine learning model(s) 124 as an executable construct (e.g., an executable file, a machine readable executable, etc.) to be executed on resource(s) of the computing system 102 and/or the external computing system(s) 130. Advantageously, the first one of the machine learning model(s) 124 has sparsity ratios that are optimized and/or otherwise increases compared to conventional network compression techniques while maintaining state-of-the-art accuracy.

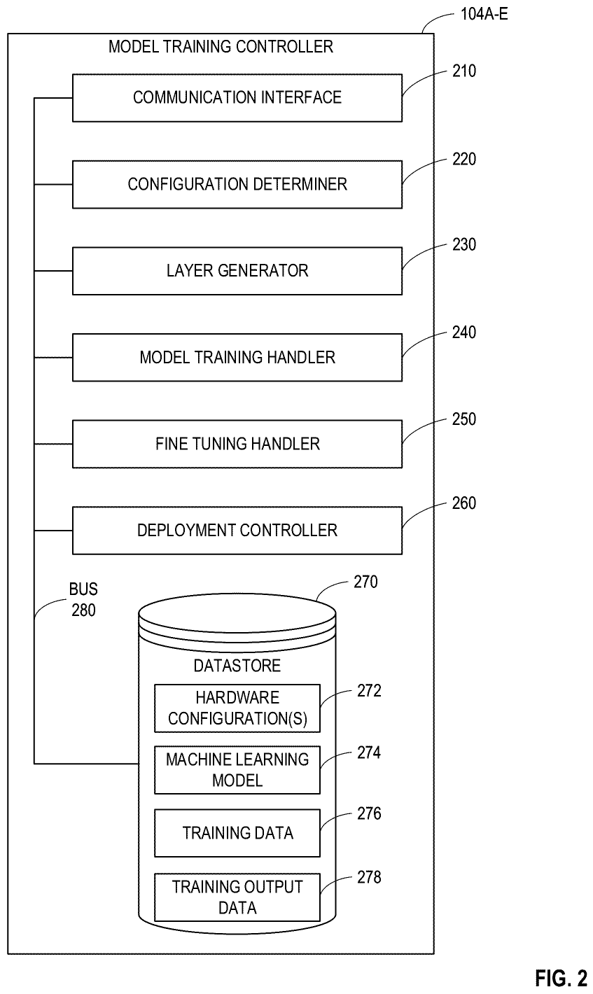

FIG. 2 is a block diagram of an example implementation of the model training controller 104A-E of FIG. 1. In some examples, the model training controller 104A-E trains one or more machine learning models (e.g., neural networks) based on information specific to a target hardware platform or portion(s) thereof. Many different types of machine learning models and/or machine learning architectures exist. In some examples, the model training controller 104A-E implements reinforcement learning to train CNN models. Using reinforcement learning enables taking actions in an environment to maximize and/or otherwise improve cumulative rewards generated by the environment. Alternatively, the model training controller 104A-E may train other types of machine learning models such as random forests, decision trees, etc., based on information specific to a target hardware platform.

In the illustrated example of FIG. 2, the model training controller 104A-E includes an example communication interface 210, an example configuration determiner 220, an example layer generator 230, an example model training handler 240, an example fine tuning handler 250, an example deployment controller 260, an example datastore 270, and an example communication bus 280. In this example, the datastore 270 includes and/or otherwise stores example hardware configuration(s) 272, an example machine learning model 274, example training data 276, an example training output data 278.

In the illustrated example of FIG. 2, any of the communication interface 210, the configuration determiner 220, the layer generator 230, the model training handler 240, the fine tuning handler 250, the deployment controller 260, and/or the datastore 270 can communicate (e.g., communicate with each other) via the communication bus 280. In some examples, the communication bus 280 is implemented using any suitable wired and/or wireless communication. In some examples, the communication bus 280 includes software, machine readable instructions, and/or communication protocols by which information is communicated among the communication interface 210, the configuration determiner 220, the layer generator 230, the model training handler 240, the fine tuning handler 250, the deployment controller 260, and/or the datastore 270.

In the illustrated example of FIG. 2, the model training controller 104A-E includes the communication interface 210 to obtain a hardware configuration, such as the hardware configuration(s) 272, associated with a target hardware platform on which a machine learning model is to be executed. For example, the communication interface 210 can obtain the hardware configuration(s) 272 from the datastore 120 of FIG. 1, the external computing system(s) 130 via the network 128, etc.

In some examples, the communication interface 210 obtains a machine learning model to be trained, such as the machine learning model 274. For example, the communication interface 210 can obtain the machine learning model 274 from the datastore 120 and/or the external computing system(s) 130. In some examples, the communication interface 210 obtains a target task (e.g., an action of an off-policy actor-critic algorithm) on which the machine learning model 274 is to operate, as well as one or more training datasets, such as the training data 276.

In the illustrated example of FIG. 2, the model training controller 104A-E includes the configuration determiner 220 to determine hardware configuration information, parameters, etc., based on the hardware configuration(s) 272. In some examples, the configuration determiner 220 identifies that the hardware configurations(s) 272 include(s) operators (e.g., functions, operations, etc.) that are conditioned for the target hardware platform, kernels that are optimized for the target hardware platform, a latency estimator that is specific to the target hardware platform, etc.

In some examples, the configuration determiner 220 determines that the hardware configuration(s) 272 include(s) at least one of memory configuration information, caching configuration information, or processing configuration information associated with the target hardware platform. For example, the configuration determiner 220 can determine that the hardware configuration(s) 272 specify memory configuration information, such as at least one of a memory type, a read memory bandwidth, a read bus width, a write memory bandwidth, a write bus width, a memory de-rate factor, or a number of memory ports associated with memory of the target hardware platform.

In some examples, the configuration determiner 220 determines that the hardware configuration(s) 272 specifies caching configuration information, such as at least one of a cache size or a cache operating frequency associated with cache memory of the target hardware platform. In some examples, the configuration determiner 220 determines that the hardware configuration(s) 124 specifies processing configuration information, such as at least one of a number of data processing units, a clock frequency, a fabric frequency, an activation precision, or a weight precision associated with one or more processors of the target hardware platform.

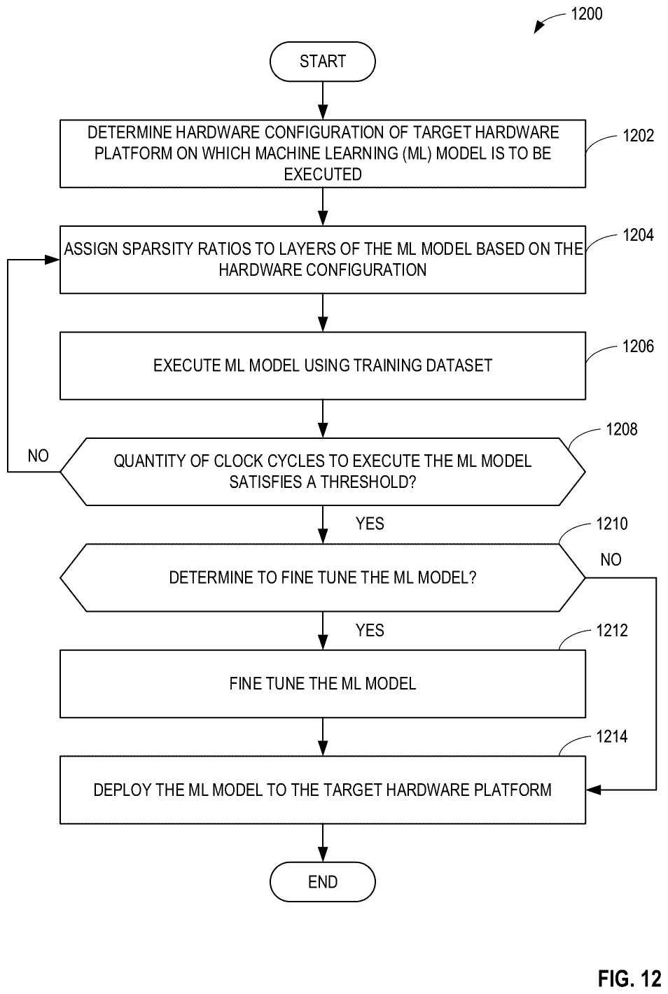

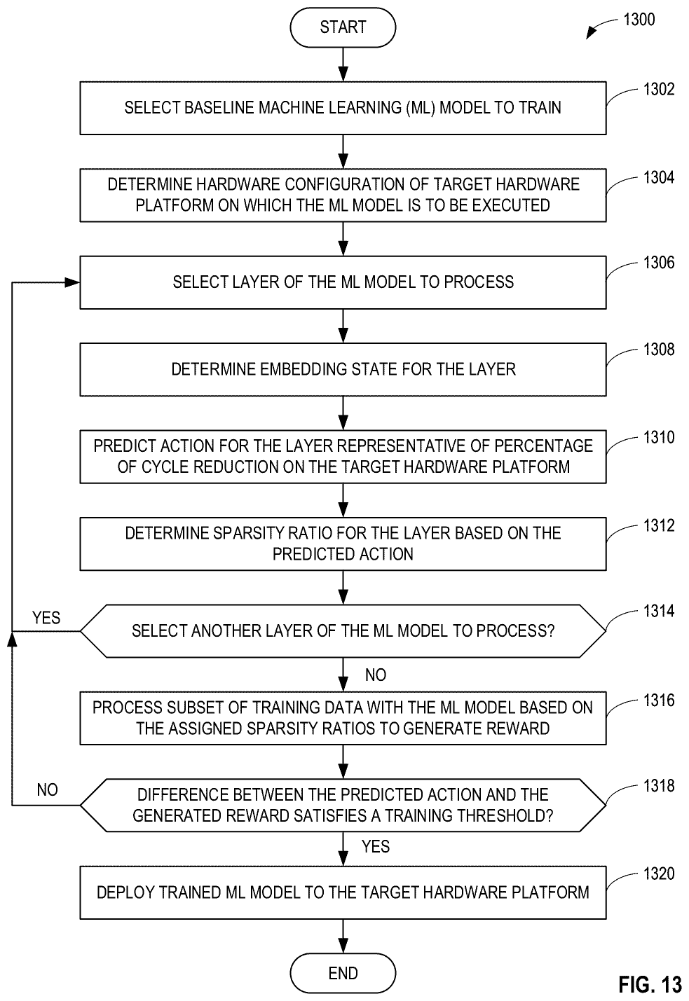

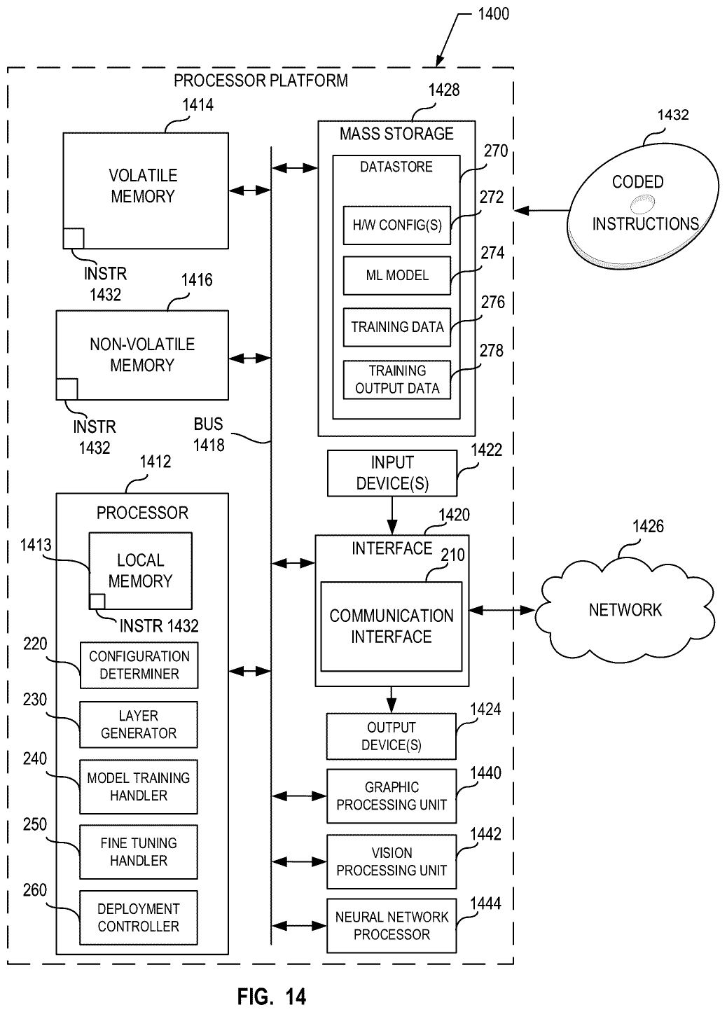

In some examples, the configuration determiner 220 implements means for determining a hardware configuration of a target hardware platform on which the machine learning model is to be executed. In some examples, the means for determining is implemented by executable instructions such as that implemented by at least block 1202 of FIG. 12 and/or block 1304 of FIG. 13. In such examples, the executable instructions of block 1202 of FIG. 12 and/or block 1304 of FIG. 13 can be executed on at least one processor such as the example processor 1412 of FIG. 14. In other examples, the means for determining is implemented by hardware logic, hardware implemented state machines, logic circuitry, and/or any other combination of hardware, software, and/or firmware.

In the illustrated example of FIG. 2, the model training controller 104A-E includes the layer generator 230 to generate a layer of a neural network by assigning a sparsity configuration to the layer based on the hardware configuration(s) 272. In some examples, the layer generator 230 selects a first layer of the layers of a neural network. In such examples, the layer generator 230 determines a sparsity configuration of the first layer, such as a sparsity ratio of 30%, 50%, etc., and assigns a zero to one or more values of a matrix of the first layer based on the sparsity ratio. As used herein, the term “sparsity ratio” refers to a ratio of (a) a number of zero-valued elements or values in a neural network layer matrix and (b) a total number of elements or values in the neural network layer matrix. For example, the layer generator 230 can generate the first layer by assigning a sparsity ratio of 30% and setting 30% of the elements of the matrix of the first layer to be zero or have zero value.

In some examples, the layer generator 230 implements means for assigning sparsity configurations to layers of the machine learning model based on a hardware configuration. For example, the means for assigning can generate one or more layers of a machine learning model based on the assignments. In some examples, the means for assigning is to select a first layer of one or more layers of a machine learning model and assign a zero to one or more values of a matrix of the first layer.

In some examples, the means for assigning is implemented by executable instructions such as that implemented by at least block 1204 of FIG. 12 and/or blocks 1306, 1312, 1314 of FIG. 13. In such examples, the executable instructions of block 1204 of FIG. 12 and/or blocks 1306, 1312, and 1314 of FIG. 13 can be executed on at least one processor such as the example processor 1412 of FIG. 14. In other examples, the means for assigning is implemented by hardware logic, hardware implemented state machines, logic circuitry, and/or any other combination of hardware, software, and/or firmware.

In the illustrated example of FIG. 2, the model training controller 104A-E includes the model training handler 240 to invoke an environment (e.g., a machine learning training environment) to generate output(s) of the machine learning model 274. In some examples, the model training handler 240 invokes the environment to generate an embedding state for a layer so that the embedding state characterizes the layer. For example, responsive to generating an action, the model training handler 240 can invoke the environment to execute the action. In such examples, responsive to executing the action, the environment generates and/or otherwise outputs the embedding state. In some such examples, the embedding state can be an array of parameters representative of statistics of a weight tensor that corresponds to the layer. In some such examples, the embedding state can include a layer index, a kernel size of the layer, an input feature, a weight or number of parameters in the layer, a number of cycles required to execute the layer on a specified hardware resource, etc. For example, the model training handler 240 can determine a quantity of clock cycles of the first acceleration resource 108 required to execute a convolution operation with a matrix having a specified sparsity ratio as determined by the layer generator 230. In such examples, the model training handler 240 can determine the quantity of clock cycles based on the embedding state.

In some examples, the model trainer handler 240 causes the environment to perform an evaluation of the machine learning model 274. For example, responsive to assigning a sparsity ratio to every layer in the machine learning model 274, the model trainer handler 240 can invoke the environment to execute the machine learning model 274 with the assigned sparsity ratios. In such examples, responsive to the execution, the machine learning model 274 can output a reward. In some such examples, the reward is an accuracy of the machine learning model 274 based on the assigned sparsity ratios. In some examples, the model trainer handler 240 can invoke the layer generator 230 to generate another set of sparsity ratios for one or more layers of the machine learning model 274.

In some examples, the model training handler 240 implements an off-policy actor-critic algorithm or portion(s) thereof (e.g., implements the actor, the critic, etc., and/or a combination thereof). An off-policy actor-critic (OPAC) algorithm implements reinforcement learning techniques. Compared to an on-policy setting, in which an agent learns only about the behavior or policy it is executing, an off-policy setting includes an agent to learn about a policy or policies different from the one it is executing. For example, the model training handler 240 can implement such an agent. In some examples, the model training handler 240 implements the OPAC algorithm by having two learners: the actor and the critic. For example, the actor can update the policy weights (e.g., the policy weighting values), the sparsity ratios, etc., and the critic can learn an off-policy estimate of the value function for the current actor policy. In such examples, the actor can use the off-policy estimate to update the policy. In some such examples, the actor can cause a new action to be generated based on the updated policy.

In some examples, the model training handler 240 implements means for determining a first quantity of clock cycles to execute a convolution operation with a matrix (e.g., a matrix of a layer of a neural network). In some examples, the machine learning model generates one or more outputs including an accuracy of the machine learning model. In such examples, the means for determining is to determine whether the accuracy satisfies an accuracy threshold, and determine whether the quantity of the clock cycles satisfies a clock cycle threshold. In some examples, the means for determining is implemented by executable instructions such as that implemented by at least blocks 1206, 1208 of FIG. 12 and/or blocks 1308, 1310, 1316, 1318 of FIG. 13. In such examples, the executable instructions of blocks 1206, 1208 of FIG. 12 and/or blocks 1308, 1310, 1316, 1318 of FIG. 13 can be executed on at least one processor such as the example processor 1412 of FIG. 14. In other examples, the means for determining is implemented by hardware logic, hardware implemented state machines, logic circuitry, and/or any other combination of hardware, software, and/or firmware.

In the illustrated example of FIG. 2, the model training controller 104A-E includes the fine tuning handler 250 to adjust the layers of the machine learning model 274. For example, in response to all actions of interest having been performed on a baseline machine learning model (e.g., an untrained machine learning model), the model training handler 240 can identify a best reward sparse model that gives a target reduction in cycles on a target hardware platform. For example, the best reward sparse model can be the machine learning model 274 having sparsity configurations (e.g., sparsity ratios) for the layers that achieves the best and/or otherwise optimal reward while achieving the target reduction in cycles compared to the baseline machine learning model. In such examples, the fine tuning handler 250 can fine tune the best reward sparse model to increase (e.g., incrementally increase) the accuracy to generate a final sparse model (e.g., a final sparse machine learning model). In some such examples, the fine tuning handler 250 fine tunes the best reward sparse model by further training the best reward sparse model with fewer Epochs (e.g., 10% fewer Epochs, 20% fewer Epochs, etc.) than used to train the best reward sparse model.

In the illustrated example of FIG. 2, the model training controller 104A-E includes the deployment controller 260 to deploy a trained version of the machine learning model 274 to a target hardware resource and/or, more generally, a target hardware platform. For example, in response to at least one of (a) an accuracy of the machine learning model 274 satisfies an accuracy threshold or (b) a number of reduction in cycles satisfies a cycle reduction threshold, the deployment controller 260 can identify the machine learning model 274 for deployment. In some examples, the deployment controller 260 discards and/or otherwise removes the machine learning model 274 from consideration for deployment if least one of (a) the accuracy of the machine learning model 274 does not satisfy the accuracy threshold or (b) the number of reduction in cycles does not satisfy the cycle reduction threshold. In some examples, the deployment controller 260 retrains the machine learning model 274 if at least one of (a) the accuracy of the machine learning model 274 does not satisfy the accuracy threshold or (b) the number of reduction in cycles does not satisfy the cycle reduction threshold. In some such examples, the deployment controller 260 directs, instructs, and/or otherwise invokes one(s) of the model training handler 240, the fine tuning handler, etc., to retrain the machine learning model 274.

In some examples, responsive to the identification, the deployment controller 260 distributes and/or otherwise deploys the machine learning model 274 to the computing system 102, the external computing system(s) 130, and/or portion(s) thereof. In such examples, the deployment controller 260 can deploy the machine learning model 274 to the CPU 106, the first acceleration resource 108, the second acceleration resource 110, the general purpose processing resource 112, and/or, more generally, to the computing system 102 of FIG. 1. In some examples, the deployment controller 260 stores the machine learning model 274 as one of the machine learning model(s) 124 in the datastore 120 of FIG. 1.

In some examples, the deployment controller 260 implements means for deploying a machine learning model to a target hardware platform in response to outputs of the machine learning model satisfying respective thresholds, the outputs including a quantity of clock cycles to execute the machine learning model with the layers of the machine learning model having assigned sparsity configurations.

In some examples, the means for deploying is to retrain the machine learning model in response to at least one of: (a) the accuracy not satisfying the accuracy threshold, or (b) the quantity of the clock cycles not satisfying the clock cycle threshold. In some examples, the means for deploying is to identify the machine learning model for deployment in response to: (a) an accuracy of the machine learning model satisfying the accuracy threshold, and (b) the quantity of the clock cycles satisfying a clock cycle threshold.

In some examples, the means for deploying is implemented by executable instructions such as that implemented by at least block 1214 of FIG. 12 and/or block 1320 of FIG. 13. In such examples, the executable instructions of block 1214 of FIG. 12 and/or block 1320 of FIG. 13 can be executed on at least one processor such as the example processor 1412 of FIG. 14. In other examples, the means for deploying is implemented by hardware logic, hardware implemented state machines, logic circuitry, and/or any other combination of hardware, software, and/or firmware.

In the illustrated example of FIG. 2, the model training controller 104A-E includes the datastore 270 to store data (e.g., the hardware configuration(s) 272, the machine learning model 274, the training data 276, the training output data 278, etc.). In this example, the datastore 270 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The example datastore 270 may additionally or alternatively be implemented by one or more double data rate (DDR) memories, such as DDR, DDR2, DDR3, DDR4, mobile DDR (mDDR), etc. The example datastore 270 may additionally or alternatively be implemented by one or more mass storage devices such as hard disk drive(s), compact disk (CD) drive(s), digital versatile disk (DVD) drive(s), solid-state disk drive(s), etc. While in the illustrated example the datastore 270 is illustrated as a single database, the datastore 270 may be implemented by any number and/or type(s) of databases. Furthermore, the data stored in the datastore 270 may be in any data format such as, for example, binary data, comma delimited data, tab delimited data, structured query language (SQL) structures, etc.

In the illustrated example of FIG. 2, the machine learning model 274 is an example implementation of one or more of the machine learning model(s) 124 of FIG. 1. For example, the machine learning model 274 can be an untrained neural network, a trained neural network, etc., or any other type of machine learning model.

In the illustrated example of FIG. 2, the training data 276 originates from known challenge sets. For example, the training data 276 can be the ImageNet dataset, the CIFAR-10 dataset, etc., or portion(s) thereof. In such examples, the training data 276 can include images or portion(s) thereof. In other examples, the training data 276 can be customized and/or otherwise non-publicly available challenge sets. In the illustrated example of FIG. 2, the training output data 278 includes one or more embedding states and/or portion(s) thereof, one or more rewards, etc., associated with an execution of the machine learning model 274.

While an example manner of implementing the model training controller 104A-E of FIG. 1 is illustrated in FIG. 2, one or more of the elements, processes and/or devices illustrated in FIG. 2 may be combined, divided, re-arranged, omitted, eliminated and/or implemented in any other way. Further, the example communication interface 210, the example configuration determiner 220, the example layer generator 230, the example model training handler 240, the example fine tuning handler 250, the example deployment controller 260, the example datastore 270, the example hardware configuration(s) 272, the example machine learning model 274, the example training data 276, the example training output data 278, the example bus 280, and/or, more generally, the example model training controller 104A-E of FIGS. 1 and/or 2 may be implemented by hardware, software, firmware and/or any combination of hardware, software and/or firmware. Thus, for example, any of the example communication interface 210, the example configuration determiner 220, the example layer generator 230, the example model training handler 240, the example fine tuning handler 250, the example deployment controller 260, the example datastore 270, the example hardware configuration(s) 272, the example machine learning model 274, the example training data 276, the example training output data 278, the example bus 280, and/or, more generally, the example model training controller 104A-E could be implemented by one or more analog or digital circuit(s), logic circuits, programmable processor(s), programmable controller(s), GPU(s), DSP(s), ASIC(s), PLD(s), and/or FPLD(s). When reading any of the apparatus or system claims of this patent to cover a purely software and/or firmware implementation, at least one of the example communication interface 210, the example configuration determiner 220, the example layer generator 230, the example model training handler 240, the example fine tuning handler 250, the example deployment controller 260, the example datastore 270, the example hardware configuration(s) 272, the example machine learning model 274, the example training data 276, the example training output data 278, and/or the example bus 280 is/are hereby expressly defined to include a non-transitory computer readable storage device or storage disk such as a memory, a digital versatile disk (DVD), a compact disk (CD), a Blu-ray disk, etc. including the software and/or firmware. Further still, the example model training controller 104A-E of FIGS. 1 and/or 2 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

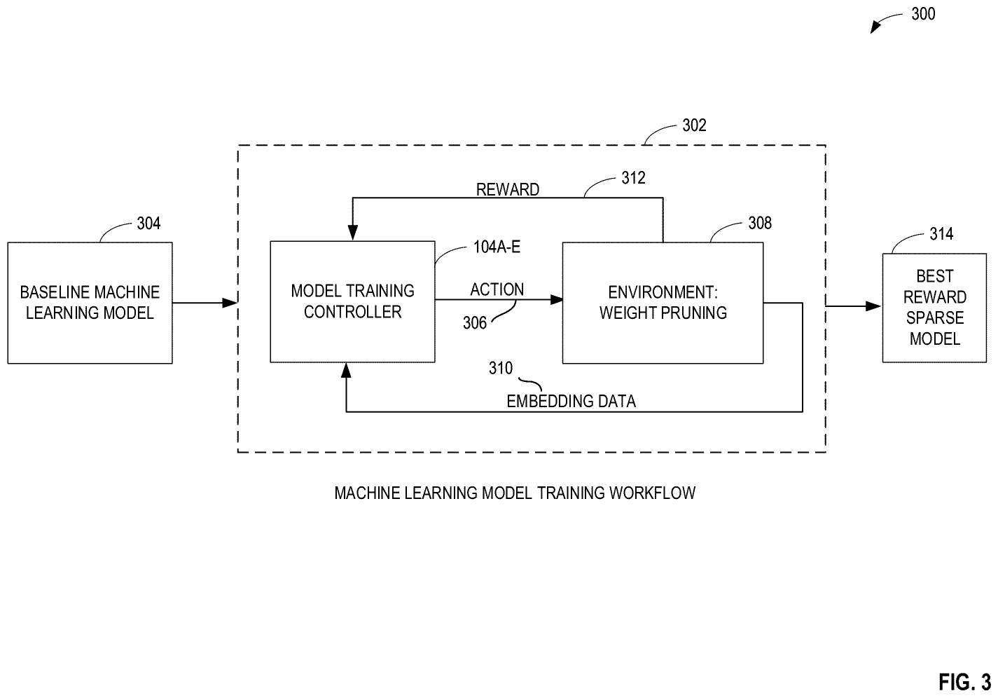

FIG. 3 is a block diagram of a first example machine learning model training system 300 including the example model training controller 104A-E of FIGS. 1 and/or 2 executing a first example machine learning model training workflow 302 to train an example baseline machine learning model 304. In this example, the baseline machine learning model 304 is an example implementation of one of the machine learning model(s) 124 of FIG. 1 and/or the machine learning model 274 of FIG. 2. For example, the baseline machine learning model 304 can be an untrained neural network retrieved from the datastore 120 of FIG. 1, the external computing system(s) 130 via the network 128 of FIG. 1, and/or from the datastore 270 of FIG. 2.

In example operation, the model training controller 104A-E retrieves and/or otherwise obtains the baseline machine learning model 304. During the first workflow 302, the model training controller 104A-E learns to predict an example action 306 that assigns a sparsity (e.g., a sparsity ratio) to a layer of the baseline machine learning model 304. During the first workflow 302, the model training controller 104A-E performs the pruning (e.g., weight pruning) for the layer in an example environment 308 to reduce the computation cycles on a target hardware platform (e.g., the CPU 106, the first acceleration resource 108, etc.). In this example, the action 306 is the percentage of cycle reduction for a layer of the baseline machine learning model 304, such as a percentage of a reduction in the number of cycles (e.g., clock cycles, computation cycles, processor cycles, etc.) in response to processing the layer having the assigned sparsity ratio. In this example, the environment 308 is tuned and/or otherwise tailored to generate outputs based on a hardware configuration (e.g., the hardware configuration(s) 122 of FIG. 1, the hardware configuration(s) 272 of FIG. 2, etc.) of a target hardware platform, such as the CPU 106, the first acceleration resource 108, the second acceleration resource 110, etc., of FIG. 1. For example, the environment 308 can be hardware, software, and/or firmware to implement an architectural or hardware benchmark routine.

In this example, the model training controller 104A-E implements a Deep Deterministic Policy Gradient (DDPG) agent. For example, the model training controller 104A-E can learn the best and/or otherwise optimal combination of sparsity ratios for the layers of the baseline machine learning model 304. Alternatively, the model training controller 104A-E may implement a different type of agent to train the baseline machine learning model 304.

In example operation, in response to the model training controller 104A-E outputting the action 306 to the environment 308, the environment 308 outputs example embedding data 310 to the model training controller 104A-E. For example, the environment 308 can calculate and/or otherwise simulate processing of a layer of the baseline machine learning model 304 having the assigned sparsity ratio defined by the action 306. In such examples, the environment 308 can execute and/or simulate a convolution operation. For example, convolutional layers of neural networks typically include an input parameter (e.g., an input channel), an output parameter (e.g., an output channel), a width parameter, and a height parameter where the total number of parameters for the layer is the product of the input parameter, the output parameter, the width parameter, and the height parameter (e.g., input*output*width*height). When executing a convolutional layer, a target hardware platform may apply a filter (sometimes referred to as a kernel) which is a c by n by w by h matrix that the target hardware platform “steps” through the input data. For example, c refers to the input channel, n refer to the output channel, w refers to the width, and h refers to the height of the filter.

The embedding data 310 is an example implementation of the training output data 278 or portion(s) thereof. In this example, the embedding data 310 is an embedding state for the layer being pruned and/or otherwise processed by the environment 308. An example implementation of the embedding data 310 is described below in Array (1):

$$( t , n , c , h , w , stride , k , weight [ t ] , cycles [ t ] , reduced , rest , a [ t - 1 ] , extra [ t ] , \qquad Array ( 1 )$$

The example of Array (1) is an example implementation of an embedding state. In the example of Array (1) above, the term t represents the layer index, the term n is an output feature size, the term c is an input feature size, h is a height value, w is a width value, stride is the number of shifts or movements of a filter (e.g., a convolution filter) over an input matrix, and the term k represents the actual kernel size. In the example of Array (1) above, the weight for the layer is n*c*k*k and the input feature is c*h*w. In the example of Array (1) above, the term weight[t] is the number of parameters in the layer t, and the term cycles[t] is the number of cycles required to process the layer t on the target hardware platform. In the example of Array (1) above, the term reduced is the total number of reduced cycles in previous layers, the term rest is the number of remaining weights in the following layers, and the term α[t−1] is the action for the previous layer. In the example of Array (1) above, the term extra[t] can be representative of any other characteristics for the layer t. Alternatively, extra[t] may be used to capture the statistics of the weight matrix by using a Hessian of the weight matrix. Alternatively, extra[t] may have a zero or null value. Alternatively, Array (1) above may have fewer or more terms.

In some examples, such as in the example of FIG. 3, a continuous action space is used (e.g., α∈(0, 1]) for the reduction of cycles for each layer. For example, continuous action can be better than discrete action as 20% reduction for cycles is much more aggressive than 10% reduction. In such examples, a continuous action space enables a larger search space as well as reduced accuracy loss.

In some examples, the action space for the baseline machine learning model 304 is limited by setting a target percentage reduction for the number of cycles on the target hardware platform. In such examples, the model training controller 104A-E learns to prune the weights in each layer to find the best combination of cycle reduction for each layer. If, during the first workflow 302, the model training controller 104A-E determines that the action (e.g., the action 306) taken cannot reach the target percentage, then the model training controller 104A-E aggressively prunes all the remaining layers to reach the target cycle reduction. Advantageously, the model training controller 104A-E can reach the target percentage reduction while achieving the best reward by using the reward function as described below in Equation (1):

$$R = Accuracy * log ( number\_of \_cycles ) , \qquad Equation ( 1 )$$

In the example of Equation (1) above, R is the reward. For example, the reward can be based on a multiplication of (i) the subset of the validation accuracy for the sparse model and (ii) a total number of cycles in logarithmic scale. For example, the term number_of_cycles refers to the total number of cycles determined to execute the plurality of layers having respective ones of the assigned sparsity ratios.

In example operation, in response to assigning a sparsity ratio to every layer of the baseline machine learning model 304, an evaluation is performed. For example, the environment 308 can perform an evaluation by invoking the baseline machine learning model 304 having the assigned sparsity ratios to process a subset of training data (e.g., the training data 276 of FIG. 2). In such examples, the environment 308 can generate an example reward 312 responsive to the processing of the subset of the training data. The reward 312 is an evaluation result that is fed back to the model training controller 104A-E to update the next prediction (e.g., the next action for each layer).

In example operation, the first workflow 302 is repeated multiple times for the model training controller 104A-E to learn a sparse and accurate model that has the best and/or otherwise optimal performance on the target hardware platform. In example operation, in response to the one or more learning iterations, the model training controller 104A-E, and/or, more generally, the first workflow 302, generates an example best reward sparse model 314. In this example, the best reward sparse model 314 is a neural network trained by the model training controller 104A-E to have high performance on the target hardware platform with substantially similar accuracy as the baseline machine learning model 304 (e.g., an accuracy within 1%, 2%, 5%, etc., of an accuracy of the baseline machine learning model 304).

Advantageously, in this example, since only forward pass is required to evaluate the sparse model to generate the reward 312, the first workflow 302 is fast and efficient and can perform on the CPU 106, the first acceleration resource 108, etc., of FIG. 1. Advantageously, in this example, the model training controller 104A-E saves and/or otherwise reduces training time by using a subset of the training data to perform the evaluation.

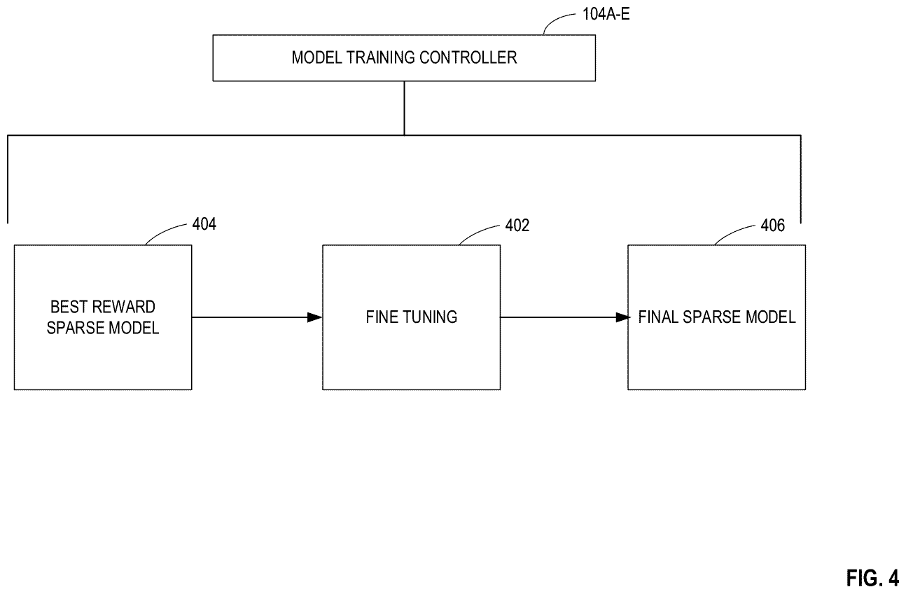

FIG. 4 is a block diagram of the example model training controller 104A-E of FIGS. 1 and/or 2 executing an example fine-tuning operation 402 on an example best reward sparse model 404 to generate an example final sparse model 406. In this example, the best reward sparse model 404 is an output from the first machine learning model training workflow 302 of FIG. 3. In this example, the best reward sparse model 404 corresponds to the best reward sparse model 314 of FIG. 3. For example, the best reward sparse model 404 can be a trained neural network having an accuracy that satisfies an accuracy threshold while reducing the total number of cycles to be executed by the target hardware platform.

In example operation, the model training controller 104A-E executes the fine-tuning operation 402 on the best reward sparse model 404. For example, the fine tuning handler 250 of FIG. 2 can apply fine tuning onto the best reward sparse model 404 to increase the accuracy by a marginal amount. In such examples, the fine tuning handler 250 can fine tune the best reward sparse model 404 by further training the best reward sparse model 404 suing fewer Epochs than the original training process. In some such examples, the fine tuning handler 250 can train the best reward sparse model 404 with 10 Epochs while the model training controller 104A-E trained the baseline machine learning model 304 with 120 Epochs (e.g., 10% less training time, where 10%=(10/120)*100).

In example operation, in response to execution of the fine-tuning operation 402, the model training controller 104A-E generates and/or otherwise outputs the final sparse model 406. In this example, the final sparse model 406 is a trained neural network. For example, the final sparse model 406 can be an example implementation of one(s) of the ML model(s) 124 of FIG. 1 and/or the machine learning model 274 of FIG. 2. Advantageously, the model training controller 104A-E can invoke the fine-tuning operation 402 to generate the final sparse model 406 to have increased accuracy compared to the best reward sparse model 404.

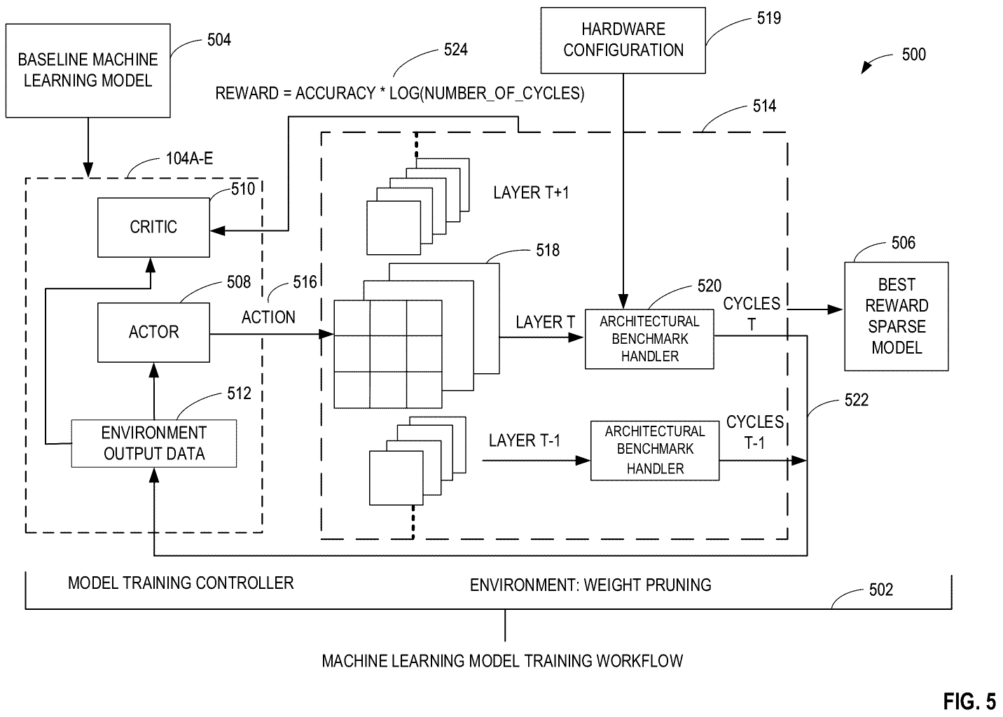

FIG. 5 is a block diagram of a second example machine learning model training system 500 including the example model training controller 104A-E of FIGS. 1 and/or 2 executing a second example machine learning model training workflow 502 to train an example baseline machine learning model 504. In this example, the baseline machine learning model 504 is an example implementation of one of the machine learning model(s) 124 of FIG. 1 and/or the machine learning model 274 of FIG. 2. For example, the baseline machine learning model 504 can be an untrained neural network retrieved from the datastore 120 of FIG. 1, the external computing system(s) 130 via the network 128 of FIG. 1, and/or from the datastore 270 of FIG. 2.

In the second workflow 502, the model training controller 104A-E generates and/or otherwise outputs an example best reward sparse model 506 by training the baseline machine learning model 504. In this example, the best reward sparse model 506 is an example implementation of the best reward sparse model 404 of FIG. 4. For example, the model training controller 104A-E can execute the fine-tuning operation 402 of FIG. 4 on the best reward sparse model 506 of FIG. 5 to generate a final sparse model, such as the final sparse model 406 of FIG. 4.

In the illustrated example of FIG. 5, the model training controller 104A-E trains the baseline machine learning model 504 by implementing an OPAC algorithm or technique. In this example, the model training controller 104A-E includes and/or otherwise implements an example actor 508 and an example critic 510. In some examples, the actor 508 is an example implementation of at least one of the layer generator 230 of FIG. 2, the model training handler 240 of FIG. 2, or portion(s) thereof. In some examples, the critic 510 is an example implementation of at least one of the layer generator 230, the model training handler 240, or portion(s) thereof.

In example operation during the second workflow 502, the actor 508 obtains example environment output data 512 from an example environment 514. In this example, the environment output data 512 can be an example implementation of the hardware configuration(s) 122 of FIG. 1, the hardware configuration(s) 272 of FIG. 2, the training output data 278 of FIG. 2, and/or the embedding data 310 of FIG. 3. In some examples, the environment output data 512 includes at least one of memory configuration information, caching configuration information, or processing configuration information associated with a target hardware platform, such as the first acceleration resource 108, the second acceleration resource 110, etc., of FIG. 1. In some examples, the environment output data 512 includes data or portion(s) thereof included in the example of Array (1) above. In this example, the environment 514 can be an example implementation of the environment 308 of FIG. 3.

In example operation during the second workflow 502, the actor 508 generates an example action 516 and transmits the action 516 to the environment 514. In this example, the action 516 is an example implementation of the action 306 of FIG. 3. For example, the actor 508 can generate the action 516 to include a sparsity ratio to be assigned to an example layer 518 of the baseline machine learning model 504. In such examples, the actor 508 determines the sparsity ratio to achieve a desired or intended percentage of reduction in cycles for a layer of interest. In this example, the layer 518 is a current or instant layer (LAYER T) of a neural network (e.g., a convolution neural network) selected to have weights (e.g., model weights, neural network weights, etc.) pruned. For example, the layer 518 is one or more matrices of the neural network. In such examples, the layer 518 can set one or more values of the one or more matrices to be zero and/or otherwise have a zero value based on the sparsity ratio defined by the action 516.

In example operation during the second workflow 502, an example architectural benchmark handler 520 receives the layer 518 having the sparsity ratio defined by the action 516. For example, the architectural benchmark handler 520 obtains a sparsity of the layer 518, a sparsity of the activation of the layer 518, a first size of inputs for the layer 518, a second size of outputs for the layer 518, etc., and/or a combination thereof. In this example, the architectural benchmark handler 520 is tuned and/or otherwise tailored to generate the environment output data 512 based on an example hardware configuration 519 (e.g., the hardware configuration(s) 122 of FIG. 1, the hardware configuration(s) 272 of FIG. 2, etc.) of a target hardware platform, such as the CPU 106, the first acceleration resource 108, the second acceleration resource 110, etc., of FIG. 1. For example, the architectural benchmark handler 520 can be hardware, software, and/or firmware to implement an architectural or hardware benchmark routine.

In example operation during the second workflow 502, the architectural benchmark handler 520 determines the environment output data 512 based on the layer 518 and the hardware configuration 519 of the target hardware platform. In this example, the architectural benchmark handler 520 generates the environment output data 512 to include an example number of cycles 522 that corresponds to the layer 518 being processed (CYCLES T).

In example operation during the second workflow 502, the actor 508 generates another action 516 based on the environment output data 512 for another layer 518 (LAYER T+1). For example, the actor 508 can generate the action 516 to assign a sparsity ratio for LAYER T+1. In such examples, the sparsity ratios for LAYER T and LAYER T+1 are different while in different examples they are the same. The architectural benchmark handler 520 determines the cycles 522 for LAYER T+1 based on the hardware configuration 519 of the target hardware platform and the sparsity ratio assigned to LAYER T+1.

In example operation during the second workflow 502, the environment 514 generates, determines, and/or otherwise outputs an example reward 524 in response to assignment of sparsity ratios to the layers 518 (e.g., all of the layers 518, a substantial portion of the layers 518, etc.). The environment 514 generates the reward 524 by invoking the neural network to execute a portion of a validation dataset, such as the training dataset 274 of FIG. 2, with the layers 518 of the neural network having sparsity ratios determined by the actor 508. For example, the environment 514 can invoke the neural network to identify one or more images from the training dataset 274.

In this example, the reward 524 is an example implementation of the reward 312 of FIG. 3. For example, the reward 524 is defined by the example of Equation (1) above. In such examples, the term number_of_cycles refers to the total number of cycles for layers 518. For example, the term number_of_cycles is a sum of a first number of cycles for LAYER T−1, a second number of cycles for LAYER T, a third number of cycles for LAYER T+1, etc.

In the illustrated example of FIG. 5, the critic 510 receives the reward 524. The model training controller 104A-E includes learn rewards from the critic 510, such as the reward 524, generated by the environment 514. In some examples, the critic 510 updates the weights of the neural network based on the reward 524. In some examples, the critic 510 provides the reward 524 to the actor 508. Advantageously, the actor 508, the critic 510, and/or, more generally, the model training controller 104A-E, learns to predict the best combination of sparsity ratios that generates the optimal cycles on the target hardware platform during the training of the baseline machine learning model 504.

In example operation during the second workflow 502, the model training controller 104A-E invokes and/or otherwise causes the environment 514 to output the best reward sparse model 506 based on the trained version of the baseline machine learning model 504 satisfying one or more thresholds. For example, the model training controller 104A-E can invoke the environment 514 to output the best reward sparse model 506 based on at least one of an accuracy (e.g., an accuracy included in the reward 524) satisfying an accuracy threshold, a percentage of the reduction in a number of cycles to be executed by the target hardware platform satisfying a cycle threshold. In some examples, the accuracy threshold is used to control a resulting accuracy of a trained machine learning model, such as the best reward sparse model 506. In examples disclosed herein, the value of the accuracy threshold can be increased by a user and/or AI to improve the resulting accuracy of the trained machine learning model. Additionally or alternatively, the value of the accuracy threshold can be decreased to generate the best reward sparse model 506 if a desired or intended accuracy threshold cannot be reached or met.

In some examples, the accuracy threshold and/or the cycle threshold is/are predetermined (e.g., determined prior to training the baseline machine learning model 504). For example, the model training handler 240, and/or, more generally, the model training controller 104A-E, can determine the accuracy threshold and/or the cycle threshold based on a type of the baseline machine learning model 504, the hardware configuration 519, etc. In such examples, the accuracy threshold and/or the cycle threshold is/are determined prior to training the baseline machine learning model 504.

In some examples, the accuracy threshold and/or the cycle threshold is/are dynamic. For example, the model training handler 240, and/or, more generally, the model training controller 104A-E, can determine the accuracy threshold and/or the cycle threshold at runtime, after processing a first layer but prior to processing a second layer, etc., based on a type of the baseline machine learning model 504, the hardware configuration 519, the environment output data 512, the reward 524, etc., and/or a combination thereof. In such examples, the model training handler 240 can increase the accuracy threshold in response to determining that the reward 524 indicates that the accuracy threshold is satisfied for one or more actions 516. In some such examples, the model training handler 240 can determine that the baseline machine learning model 504 can achieve and/or otherwise secure an increased accuracy with increased training, retraining, etc.

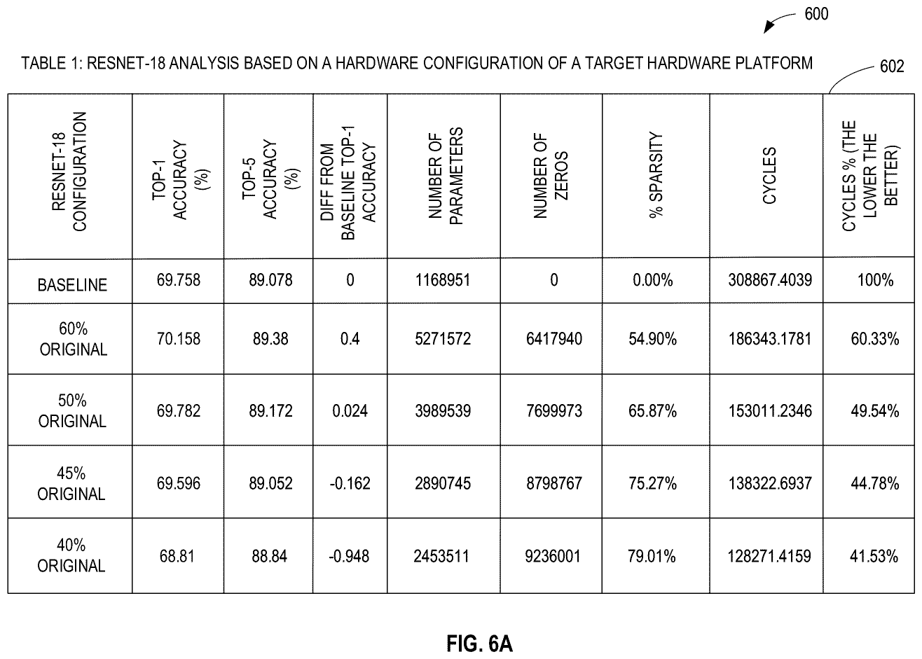

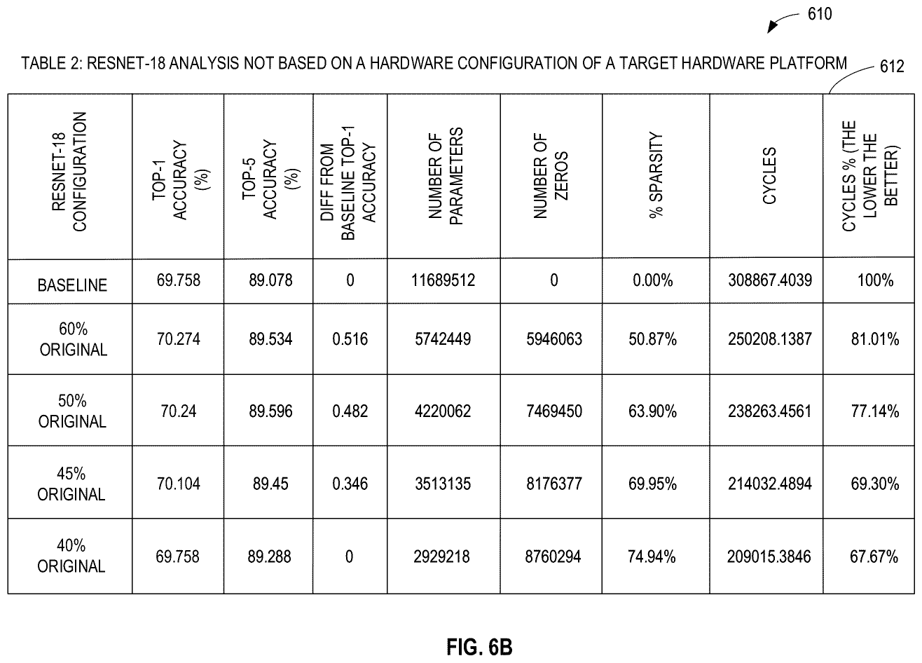

FIG. 6A depicts a first table 600 of first example output data 602 from a first example machine learning model trained by the example model training controller 104A-E of FIGS. 1 and/or 2. In this example, the first machine learning model is a ResNet-18 model. ResNet-18 is a convolutional neural network that is 18 layers deep. For example, the first output data 602 is generated from a ResNet-18 model trained by the model training controller 104A-E based on a hardware configuration of a target hardware platform on which the trained ResNet-18 model is to be executed.

The first output data 602 of the first table 600 includes a ResNet-18 configuration, a Top-1 Accuracy (%) column), a Top-5 Accuracy (%) column, a difference from baseline Top-1 Accuracy column, a number of parameters column, a number of zeros column, a sparsity percentage column, a number of cycles column, and a cycles percentage column. In this example, the ResNet-18 configuration includes a first ResNet-18 configuration, a second ResNet-18 configuration, a third ResNet-18 configuration, a fourth ResNet-18 configuration, and a fifth ResNet-18 configuration. The first ResNet-18 configuration is a baseline or untrained configuration, the second ResNet-18 configuration is a configuration that has approximately 60% of the number of cycles of the first ResNet-18 configuration, the third ResNet-18 configuration is a configuration that has approximately 50% of the number of cycles of the first ResNet-18 configuration, etc.

The Top-1 Accuracy is representative of a percentage of how often an output of the ResNet-18 model matches the expected result. The Top-5 Accuracy is representative of a percentage of how often the top five outputs (e.g., the five outputs having the highest probabilities) of the ResNet-18 model includes the expected result. The difference from baseline Top-1 Accuracy is representative of a difference between Top-1 Accuracies from different ResNet-18 configurations. The number of parameters is representative of a total number of elements (e.g., matrix elements) or parameters (e.g., matrix parameters) that have a non-zero value. The number of zeros is representative of a total number of elements (e.g., matrix elements) or parameters (e.g., matrix parameters) that have a zero value. The sparsity percentage is representative of a ratio of the number of zeros and the total number of possible parameters. In this example, the total number of possible parameters is 11,689,512. The number of cycles is representative of a total number of cycles (e.g., clock cycles, instruction cycles, processor cycles) needed to execute the ResNet-18 model. The cycles percentage is representative of a percentage of the total number of cycles with respect to the baseline configuration.

FIG. 6B depicts a second table 610 of second example output data 612 from a second example machine learning model not trained by the example model training controller 104A-E of FIGS. 1 and/or 2. In this example, the second machine learning model is a ResNet-18 model. For example, the second output data 612 is generated from a ResNet-18 model that is not trained by the model training controller 104A-E and, thus, may not be based on a hardware configuration of a target hardware platform. In such examples, the ResNet-18 model can be trained using conventional training techniques.

The second output data 612 of the second table 610 includes a ResNet-18 configuration, a Top-1 Accuracy (%) column), a Top-5 Accuracy (%) column, a difference from baseline Top-1 Accuracy column, a number of parameters column, a number of zeros column, a sparsity percentage column, a number of cycles column, and a cycles percentage column. In this example, the ResNet-18 configuration includes a first ResNet-18 configuration, a second ResNet-18 configuration, a third ResNet-18 configuration, a fourth ResNet-18 configuration, and a fifth ResNet-18 configuration. The first ResNet-18 configuration is a baseline or untrained configuration, the second ResNet-18 configuration is a configuration that has a sparsity ratio of approximately 50%, the third ResNet-18 configuration is a configuration that has a sparsity ratio of approximately 60%, etc.

In the examples of FIGS. 6A-6B, the first output data 602 and the second output data 612 are generated by machine learning models trained using Reinforcement Learning. In the examples of FIGS. 6A-6B, the machine learning models are trained with the same duration of the Reinforcement Learning and the same number of Epochs used during fine-tuning. Advantageously, the first machine learning model that generates the first output data 602 has greater reductions in cycles (e.g., lower cycle percentages) while maintaining substantially similar (e.g., within 1%, 2%, etc., Top-1 Accuracy and Top-5 Accuracy compared to the second output data 612 generated by the second machine learning model. Advantageously, the model training controller 104A-E can train and/or otherwise output sparse models having reduced number of cycles to execute the sparse models compared to conventional machine learning training techniques.

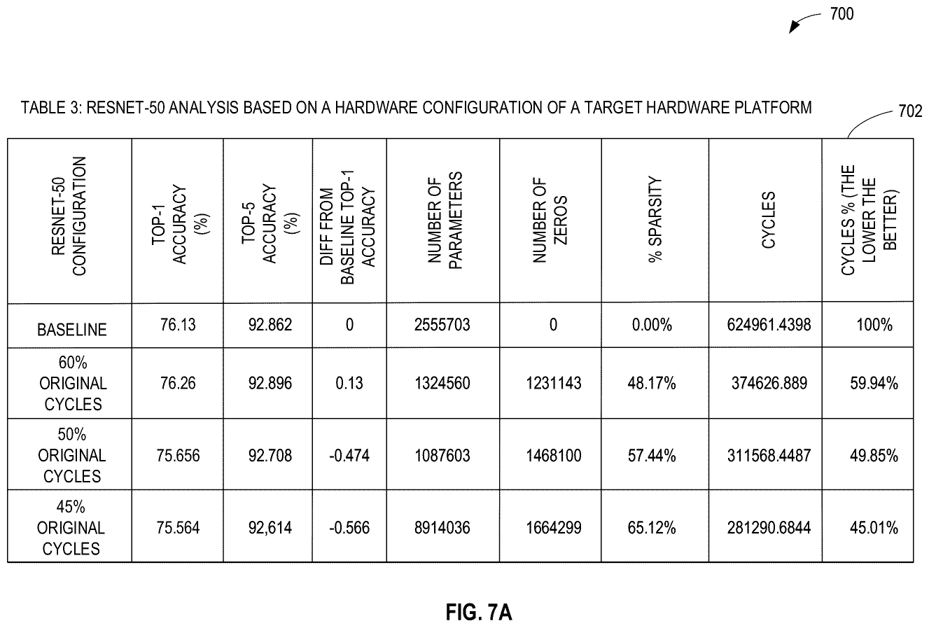

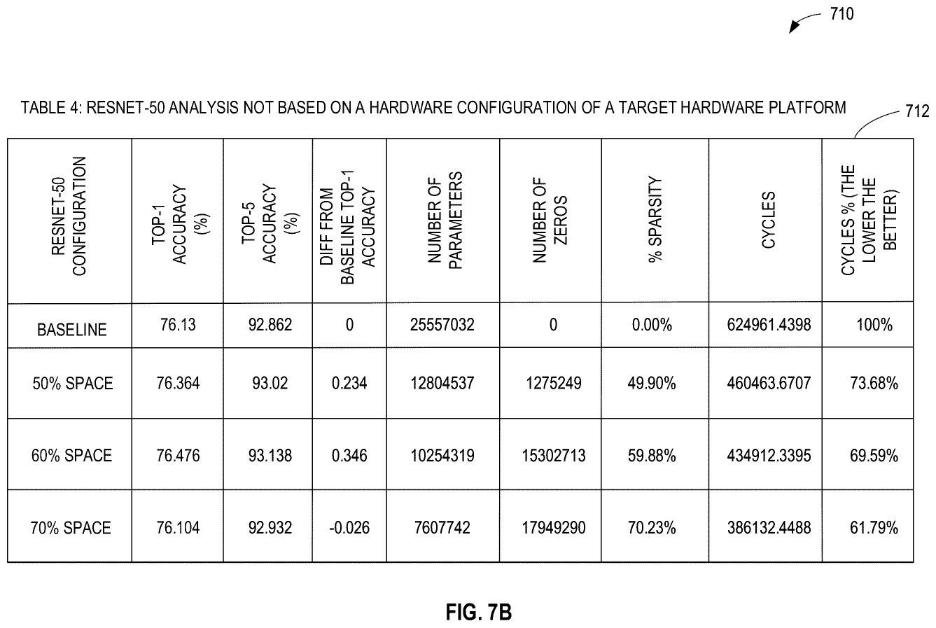

FIG. 7A depicts a third table 700 of third example output data 702 from a third example machine learning model trained by the example model training controller 104A-E of FIGS. 1 and/or 2. In this example, the third machine learning model is a ResNet-50 model. ResNet-50 is a convolutional neural network that is 50 layers deep. For example, the third output data 702 is generated from a ResNet-50 model trained by the model training controller 104A-E based on a hardware configuration of a target hardware platform on which the trained ResNet-50 model is to be executed.

FIG. 7B depicts a fourth table 710 of fourth example output data 712 from a fourth example machine learning model not trained by the example model training controller 104A-E of FIGS. 1 and/or 2. In this example, the fourth machine learning model is a ResNet-50 model. For example, the fourth output data 712 is generated from a ResNet-50 model that is not trained by the model training controller 104A-E and, thus, may not be based on a hardware configuration of a target hardware platform. In such examples, the ResNet-50 model can be trained using conventional training techniques.

The third output data 702 of the third table 700 and the fourth output data 712 of the fourth table 710 include a ResNet-50 configuration, a Top-1 Accuracy (%) column), a Top-5 Accuracy (%) column, a difference from baseline Top-1 Accuracy column, a number of parameters column, a number of zeros column, a sparsity percentage column, a number of cycles column, and a cycles percentage column. In the example of FIG. 7A, the ResNet-50 configuration of the third output data 702 includes a first ResNet-50 configuration, a second ResNet-50 configuration, a third ResNet-50 configuration, and a fourth ResNet-50 configuration. The first ResNet-50 configuration is a baseline or untrained configuration, the second ResNet-50 configuration is a configuration that has approximately 60% of the number of cycles of the first ResNet-50 configuration, the third ResNet-50 configuration is a configuration that has approximately 50% of the number of cycles of the first ResNet-50 configuration, etc.

In the example of FIG. 7B, the ResNet-50 configuration includes a first ResNet-50 configuration, a second ResNet-50 configuration, a third ResNet-50 configuration, and a fourth ResNet-50 configuration. The first ResNet-50 configuration is a baseline or untrained configuration, the second ResNet-50 configuration is a configuration that has a sparsity ratio of approximately 50%, the third ResNet-50 configuration is a configuration that has a sparsity ratio of approximately 60%, etc.

In the examples of FIGS. 7A-7B, the third output data 702 and the fourth output data 712 are generated by machine learning models trained using Reinforcement Learning. In the examples of FIGS. 7A-7B, the machine learning models are trained with the same duration of the Reinforcement Learning and the same number of Epochs used during fine-tuning. Advantageously, the third machine learning model that generates the third output data 702 has greater reductions in cycles (e.g., lower cycle percentages) while maintaining substantially similar (e.g., within 1%, 2%, etc., Top-1 Accuracy and Top-5 Accuracy compared to the fourth output data 712 generated by the fourth machine learning model. Advantageously, the model training controller 104A-E can train and/or otherwise output sparse models having reduced number of cycles to execute the sparse models compared to conventional machine learning training techniques.

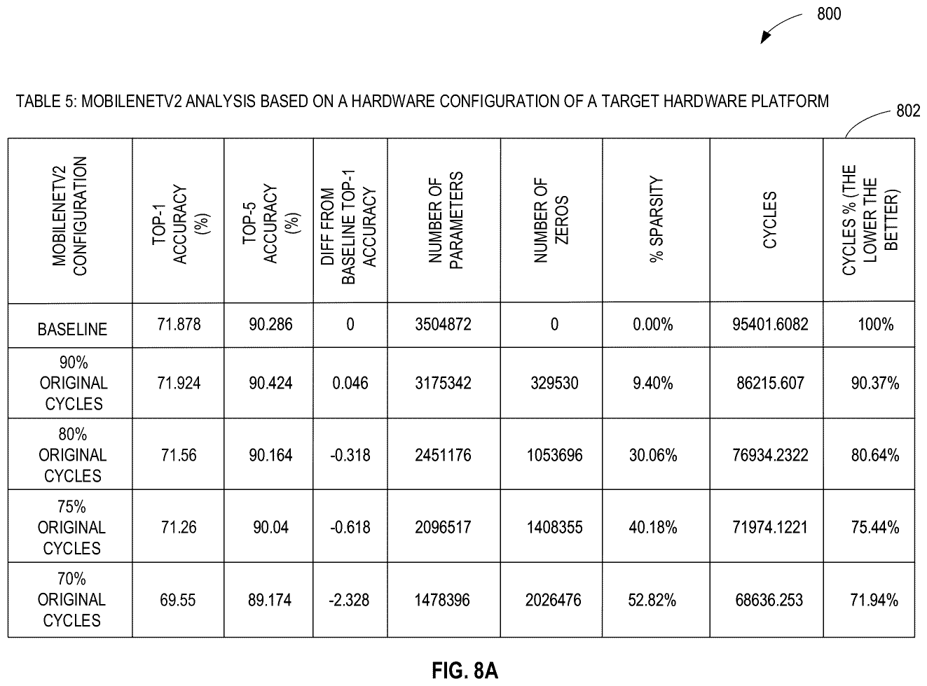

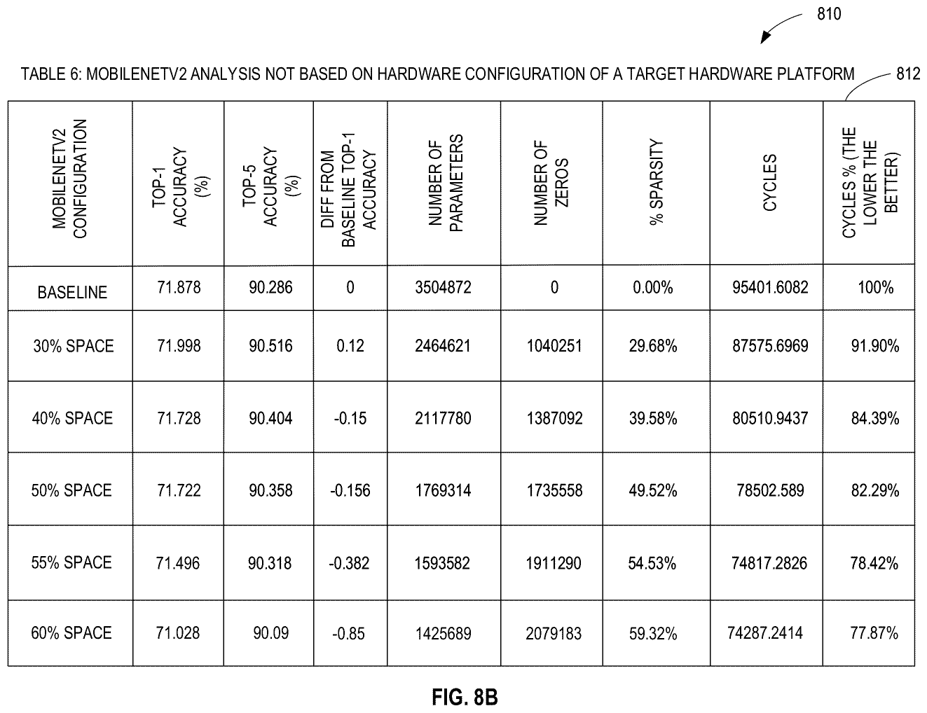

FIG. 8A depicts a fifth table 800 of fifth example output data 802 from a fifth example machine learning model trained by the example model training controller 104A-E of FIGS. 1 and/or 2. In this example, the fifth machine learning model is a MobileNetv2 model. MobileNetv2 is a convolutional neural network that is directed to mobile computing devices, or devices that may be power limited. For example, the fifth output data 802 is generated from a MobileNetv2 model trained by the model training controller 104A-E based on a hardware configuration of a target hardware platform on which the trained MobileNetv2 model is to be executed.

FIG. 8B depicts a sixth table 810 of sixth example output data 812 from a sixth example machine learning model not trained by the example model training controller 104A-E of FIGS. 1 and/or 2. In this example, the sixth machine learning model is a MobileNetv2 model. For example, the sixth output data 812 is generated from a MobileNetv2 model that is not trained by the model training controller 104A-E and, thus, may not be based on a hardware configuration of a target hardware platform. In such examples, the MobileNetv2 model can be trained using conventional training techniques.

The fifth output data 802 of the fifth table 800 and the sixth output data 812 of the sixth table 810 include a MobileNetv2 configuration, a Top-1 Accuracy (%) column), a Top-5 Accuracy (%) column, a difference from baseline Top-1 Accuracy column, a number of parameters column, a number of zeros column, a sparsity percentage column, a number of cycles column, and a cycles percentage column. In the example of FIG. 8A, the MobileNetv2 configuration of the fifth output data 802 includes a first MobileNetv2 configuration, a second MobileNetv2 configuration, a third MobileNetv2 configuration, a fourth MobileNetv2 configuration, and a fifth MobileNetv2 configuration. The first MobileNetv2 configuration is a baseline or untrained configuration, the second MobileNetv2 configuration is a configuration that has approximately 90% of the number of cycles of the first MobileNetv2 configuration, the third MobileNetv2 configuration is a configuration that has approximately 80% of the number of cycles of the first MobileNetv2 configuration, etc.

In the example of FIG. 8B, the MobileNetv2 configuration includes a first MobileNetv2 configuration, a second MobileNetv2 configuration, a third MobileNetv2 configuration, a fourth MobileNetv2 configuration, a fifth MobileNetv2 configuration, and a sixth MobileNetv2 configuration. The first MobileNetv2 configuration is a baseline or untrained configuration, the second MobileNetv2 configuration is a configuration that has a sparsity ratio of approximately 30%, the third MobileNetv2 configuration is a configuration that has a sparsity ratio of approximately 40%, etc.

In the examples of FIGS. 8A-8B, the fifth output data 802 and the sixth output data 812 are generated by machine learning models trained using Reinforcement Learning. In the examples of FIGS. 8A-8B, the machine learning models are trained with the same duration of the Reinforcement Learning and the same number of Epochs used during fine-tuning. Advantageously, the fifth machine learning model that generates the fifth output data 802 has greater reductions in cycles (e.g., lower cycle percentages) while maintaining substantially similar (e.g., within 1%, 2%, etc., Top-1 Accuracy and Top-5 Accuracy compared to the sixth output data 812 generated by the sixth machine learning model. Advantageously, the model training controller 104A-E can train and/or otherwise output sparse models having reduced number of cycles to execute the sparse models compared to conventional machine learning training techniques.

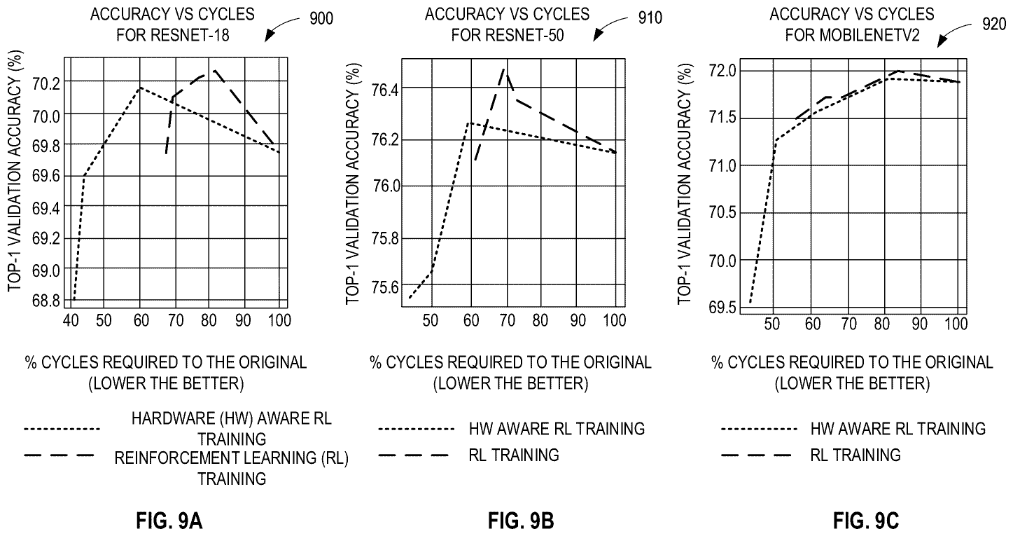

FIG. 9A is a first example graph 900 based on the first example output data 602 of FIG. 6A and the second example output data 612 of FIG. 6B. FIG. 9B is a second example graph 910 based on the third example output data 702 of FIG. 7A and the fourth example output data 712 of FIG. 7B. FIG. 9C is a third example graph 920 based on the fifth example output data 802 of FIG. 8A and the sixth example output data 812 of FIG. 8B. The graphs 900, 910, 920 depict Top-1 Accuracy (%) with respect to cycle percentages. Advantageously, the graphs 900, 910, 920 demonstrate that machine learning models trained based on a hardware configuration of a target hardware platform reduces the number of cycles to be executed on the target hardware platform. For example, in the first graph 900, the first output data 602 generated by the first machine learning model can deliver substantially similar accuracy compared to the second output data 612 generated by the second machine learning model while requiring fewer cycles to operate.

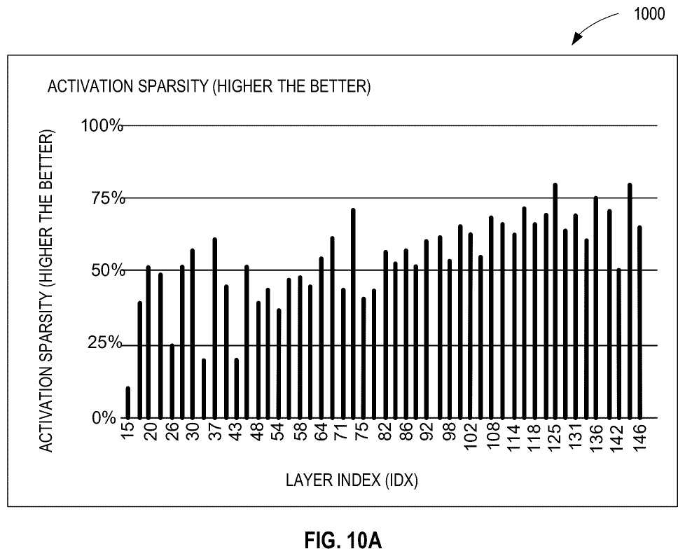

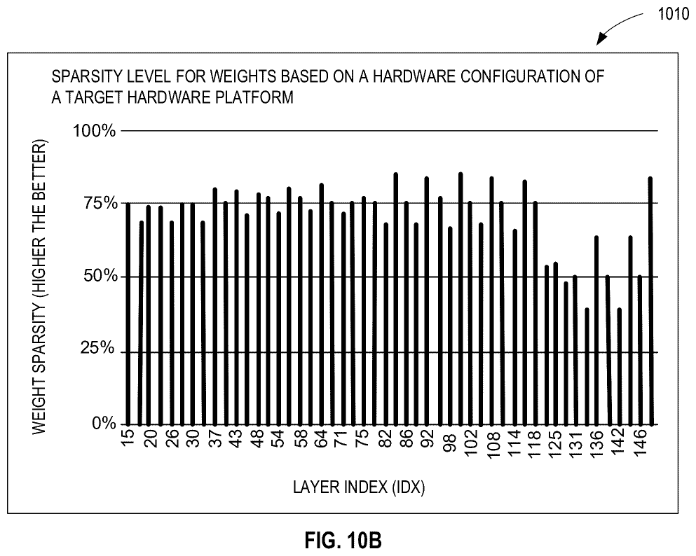

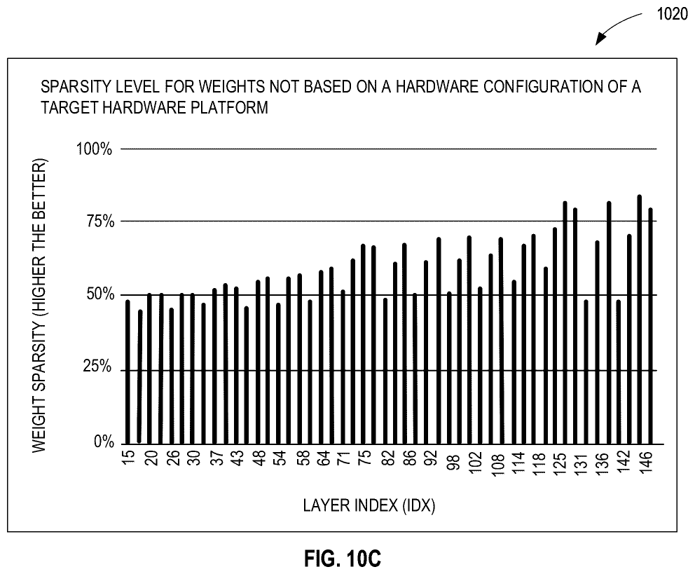

FIG. 10A is a first graph 1000 of example activation sparsity percentages with respect to example layer indices. In this example, the activation sparsity percentages and the layer indices correspond to a ResNet-50 model. In some instances, a machine learning training technique, such as Reinforcement Learning, can sparsify the ResNet-50 model by pruning as many activation weights as possible while maintaining a desired level of accuracy. In such instances, as depicted in the example of FIG. 10A, the Reinforcement Learning technique prunes more activation weights in the later layers rather than in the earlier layers. In some such instances, the earlier layers are typically more important to the accuracy of the ResNet-50 model and, thus, are not as pruned as much as the later layers.

FIG. 10B is a second graph 1010 of example sparsity percentages with respect to example layer indices for an example machine learning model trained by the example model training controller 104A-E of FIGS. 1 and/or 2. For example, the second graph 1010 can be associated with the machine learning model(s) 124 of FIG. 1, the machine learning model 274 of FIG. 2, etc., trained by the model training controller 104A-E based on a hardware configuration of a target hardware platform.

Advantageously, in some examples, the model training controller 104A-E trains a machine learning model by taking activation sparsity into account when considering the hardware efficiency of the target hardware platform, considering that the activation sparsity for the later layers in machine learning models, such as ResNet-50, are much higher than for the earlier layers. For example, for some target hardware platforms, once activation sparsity reaches and/or otherwise approaches a certain level, the weight sparsity cannot introduce as much speed up, therefore, the later layers do not need to be pruned as much while in contrast the earlier layers need to be pruned more to have increased target hardware platform performance. Such increased pruning of earlier layers is demonstrated in the example of FIG. 10B.

FIG. 10C is a third graph 1020 of example sparsity percentages with respect to example layer indices for an example machine learning model not trained by the example model training controller 104A-E of FIGS. 1 and/or 2. For example, the third graph 1020 can be associated with a machine learning model not trained based on a hardware configuration of a target hardware platform. In the example of FIG. 10C, a training agent (e.g., a Reinforcement Learning agent) prunes more than 75% of the weights in the last few layers while only pruning less than 50% in the early layers. Advantageously, the model training controller 104A-E can prune the earlier layers at approximately 75% sparsity (as depicted in FIG. 10B) while the later layers only contain less than 50% sparsity. Advantageously, by pruning the earlier layers more than the later layers, the model training controller 104A-E can train a machine learning model to achieve greater sparsity while reducing the number of cycles when compared to other machine learning training techniques.

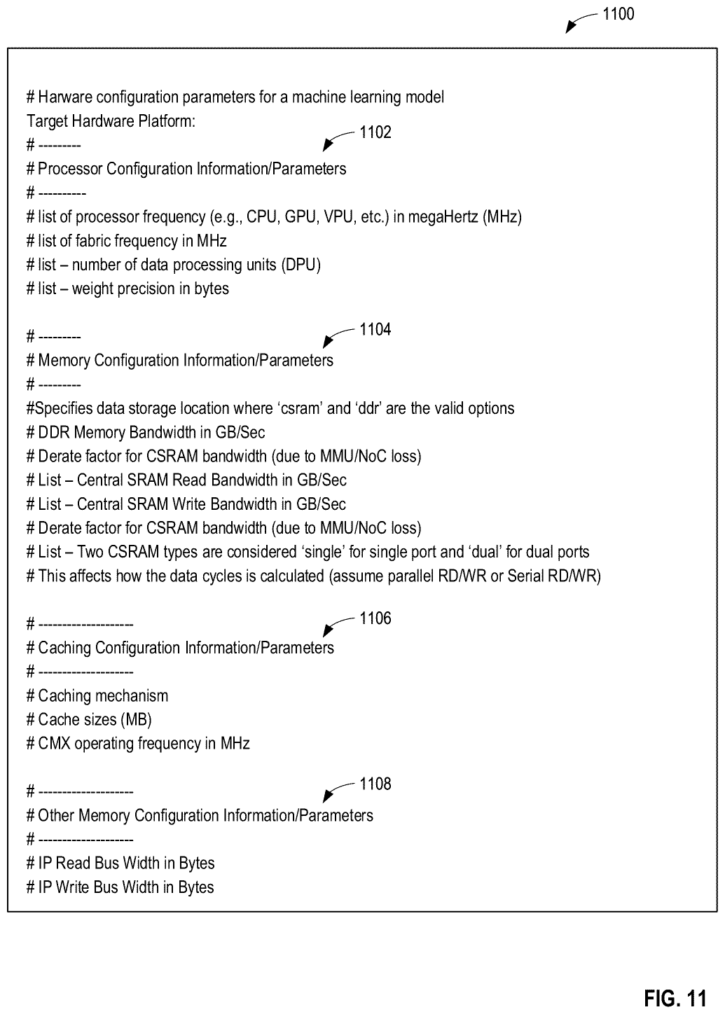

FIG. 11 depicts an example hardware configuration 1100 that may be used by the example model training controller 104A-E of FIGS. 1 and/or 2 to train an example machine learning model, such as the machine learning model(s) 124 of FIG. 1, the machine learning model 274 of FIG. 2, etc. The hardware configuration 1100 of FIG. 11 can be an example implementation of the hardware configuration(s) 122 of FIG. 1, the hardware configuration(s) 272 of FIG. 2, and/or the hardware configuration 519 of FIG. 5.

In the illustrated example of FIG. 11, the hardware configuration 1100 includes example processing or processor configuration information 1102, first example memory configuration information 1104, example caching configuration information 1106, and second example memory configuration information 1108 associated with a target hardware platform, such as the CPU 106, the first acceleration resource 108, the second acceleration resource 110, etc., of FIG. 1. In this example, the processor configuration information 1102 includes parameters associated with a processor or clock frequency, a fabric frequency, a number of data processing units (DPU), an activation precision, and a weight precision associated with one or more processors or other processing elements of the target hardware platform.

In the illustrated example of FIG. 11, the first memory configuration information 1104 includes parameters associated with specify memory configuration information, such as at least one of a memory type (e.g., Clock Synchronous Random Access Memory (CSRAM), DDR, etc.), a read memory bandwidth, a write memory bandwidth, a memory de-rate factor, or a number of memory ports associated with memory of the target hardware platform. In this example, the second memory configuration information 1108 includes parameters associated with a read bus width and a write bus width associated with the memory of the target hardware platform. In this example, the caching configuration information 1106 includes parameters associated with a cache size or a cache operating frequency associated with cache memory of the target hardware platform.

Flowcharts representative of example hardware logic, machine readable instructions, hardware implemented state machines, and/or any combination thereof for implementing the model training controller 104A-E 104 of FIGS. 1 and/or 2 is shown in FIGS. 12-13. The machine readable instructions may be one or more executable programs or portion(s) of an executable program for execution by a computer processor and/or processor circuitry, such as the processor 1412 shown in the example processor platform 1400 discussed below in connection with FIG. 14. The program(s) may be embodied in software stored on a non-transitory computer readable storage medium such as a CD-ROM, a floppy disk, a hard drive, a DVD, a Blu-ray disk, or a memory associated with the processor 1412, but the entirety of the program(s) and/or parts thereof could alternatively be executed by a device other than the processor 1412 and/or embodied in firmware or dedicated hardware. Further, although the example program(s) is/are described with reference to the flowcharts illustrated in FIGS. 12-13, many other methods of implementing the example model training controller 104A-E may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example processes of FIGS. 12-13 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 12 is a flowchart representative of example machine readable instructions 1200 that may be executed to implement the example model training controller 104A-E of FIGS. 1 and/or 2 to train a machine learning model based on a configuration of a target hardware platform. The example machine readable instructions 1200 begin at block 1202, at which the example model training controller 104A-E determines a hardware configuration of a target hardware platform on which a machine learning model is to be executed. For example, the configuration determiner 220 (FIG. 2) can determine at least one of processor configuration information, memory configuration information, or caching configuration information included in the hardware configuration(s) 122 of FIG. 1, the hardware configuration 272 of FIG. 2, the hardware configuration 519 of FIG. 5, the hardware configuration 1100 of FIG. 11, etc., associated with the first acceleration resource 108 of FIG. 1.

At block 1204, the example model training controller 104A-E assigns sparsity ratios to layers of the machine learning model based on the hardware configuration. For example, the layer generator 230 (FIG. 2) can assign a first sparsity ratio of 75% to LAYER T of FIG. 5, a second sparsity ratio of 70% to LAYER T+1 of FIG. 5, etc.

At block 1206, the example model training controller 104A-E executes the machine learning model using a target dataset. For example, the model training handler 240 (FIG. 2) can invoke the architectural benchmark handler 520 of FIG. 5 to process the training data 276, or portion(s) thereof, using the machine learning model with LAYER T having the first sparsity ratio, LAYER T+1 having the second sparsity ratio, etc.

At block 1208, the example model training controller 104A-E determines whether a quantity of clock cycles to execute the machine learning model satisfies a threshold. For example, the model training handler 240 can determine whether a quantity of clock cycles of the first acceleration resource 108 to process the training data 276, or portion(s) thereof, using the assigned sparsity ratios satisfies a threshold quantity of clock cycles by being less than the threshold quantity of clock cycles. In such examples, the deployment controller 260 can retrain, invoke the model training handler 240 to retrain, etc., the machine learning model in response to determining that the quantity of clock cycles does not satisfy the threshold quantity of clock cycles.

If, at block 1208, the example model training controller 104A-E determines that the quantity of clock cycles to execute the machine learning model does not satisfy the threshold, control returns to block 1204 to assign one or more different sparsity ratios to the layers of the machine learning model based on the hardware configuration. If, at block 1208, the example model training controller 104A-E determines that the quantity of clock cycles to execute the machine learning model satisfies the threshold, then, at block 1210, the model training controller 104A-E determines whether to fine tune the machine learning model. For example, the fine tuning handler 250 (FIG. 2) can determine that an accuracy of the best reward sparse model 404 of FIG. 4 is less than an accuracy threshold and, thus, does not satisfy the accuracy threshold.

If, at block 1210, the example model training controller 104A-E determines not to fine tune the machine learning model, control proceeds to block 1214 to deploy the machine learning model to the target hardware platform. If, at block 1210, the example model training controller 104A-E determines to fine tune the machine learning model, then, at block 1212, the model training controller 104A-E fine tunes the machine learning model. For example, the fine tuning handler 250 (FIG. 2) can invoke the fine-tuning operation 402 on the best reward sparse model 404 to generate the final sparse model 406 of FIG. 4. In such examples, the fine tuning handler 250 can invoke the fine-tuning operation to cause the final sparse model 406 to increase a first accuracy of the best reward sparse model 404 to a second accuracy greater than the first accuracy. In some such examples, the second accuracy can be greater than or equal to an accuracy threshold and, thus, satisfies the accuracy threshold.

At block 1214, the example model training controller 104A-E deploys the machine learning model to the target hardware platform. For example, the deployment controller 260 (FIG. 2) can deploy, distribute, and/or otherwise provide the final sparse model 406 to one or more target hardware platforms, such as the CPU 106, the first acceleration resource 108, etc., of FIG. 1. In such examples, the first acceleration resource 108 can execute and/or otherwise facilitate completion of one or more machine learning tasks, such as computer vision tasks, image processing tasks, etc., and/or a combination thereof. In some examples, the deployment controller 260 can store the final sparse model 406 in the datastore 120. In such examples, the final sparse model 406 can be transmitted from the first computing system 102 to one(s) of the external computing system(s) 130 via the network 128 of FIG. 1. After deploying the machine learning model to the target hardware platform at block 1214, the example machine readable instructions 1200 of FIG. 12 conclude.

FIG. 13 is a flowchart representative of example machine readable instructions 1300 that may be executed to implement the example model training controller 104A-E of FIGS. 1 and/or 2 to train a machine learning model based on a configuration of a target hardware platform. The example machine readable instructions 1300 of FIG. 13 begin at block 1302, at which the example model training controller 104A-E selects a baseline machine learning model to train. For example, the communication interface 210 (FIG. 2) can obtain the baseline machine learning model 304 of FIG. 3 for training.

At block 1304, the example model training controller 104A-E determines a hardware configuration of a target hardware platform on which the machine learning model is to be executed. For example, the configuration determiner 220 (FIG. 2) can determine at least one of processor configuration information, memory configuration information, or caching configuration information included in the hardware configuration(s) 122 of FIG. 1, the hardware configuration 272 of FIG. 2, the hardware configuration 519 of FIG. 5, the hardware configuration 1100 of FIG. 11, etc., associated with the first acceleration resource 108 of FIG. 1.

At block 1306, the example model training controller 104A-E selects a layer of the machine learning model to process. For example, the layer generator 230 (FIG. 2) can select a first one of the layers 518 of FIG. 5 to process, such as LAYER T.

At block 1308, the example model training controller 104A-E determines an embedding state for the layer. For example, the model training handler 240 (FIG. 2) can direct, instruct, and/or otherwise invoke the architectural benchmark handler 520 to output the environment output data 512, which can include the embedding state as defined by the example of Array (1) above.

At block 1310, the example model training controller 104A-E predicts an action for the layer representative of percentage of cycle reduction on the target hardware platform. For example, the model training handler 240 can predict and/or otherwise generate the action 516 of FIG. 5. In such examples, the action 516 can be a percentage in the reduction of clock cycles responsive to assigning sparsity ratio(s) to one(s) of the levels 518.

At block 1312, the example model training controller 104A-E determines a sparsity ratio for the layer based on the predicted action. For example, the layer generator 230 (FIG. 2) can assign a first sparsity ratio to a first one of the layers 518 based on the action 516.

At block 1314, the example model training controller 104A-E determines whether to select another layer of the machine learning model to process. For example, the layer generator 230 can determine to select a second one of the layers 518 to process, such as LAYER T+1 of FIG. 5.

If, at block 1314, the example model training controller 104A-E determines to select another layer of the machine learning model to process, control returns to block 1306 to select another layer of the machine learning model to process. If, at block 1314, the example model training controller 104A-E determines not to select another layer of the machine learning model to process, then, at block 1316, the model training controller 104A-E processes a subset of training data with the machine learning model based on the assigned sparsity ratios to generate a reward. For example, the model training handler 240 can direct the architectural benchmark handler 520, and/or, more generally, the environment 514 of FIG. 5, to output the reward 524 of FIG. 5 using a portion of the training data 276 (FIG. 2).

At block 1318, the example model training controller 104A-E determines whether a difference between the predicted action and the generated reward satisfies a training threshold. For example, the model training handler 240 can determine whether the reward 524 indicates that an accuracy of the machine learning model having the assigned sparsity ratios satisfies a training threshold, such as an accuracy threshold. In such examples, the model training handler 240 can instruct the environment 514 to output the best reward sparse model 506 of FIG. 5 in response to at least the accuracy of the machine learning model satisfying the training threshold. In some examples, the deployment controller 260 retrains, invokes the model training handler 240 to retrain, etc., the machine learning model in response to determining that the accuracy of the machine learning model having the assigned sparsity ratios does not satisfy the training threshold.

If, at block 1318, the example model training controller 104A-E determines that the difference between the predicted action and the generated reward does not satisfy the training threshold, control returns to block 1306 to select another layer of the learning model to process. If, at block 1318, the example model training controller 104A-E determines that the difference between the predicted action and the generated reward satisfies the training threshold, then, at block 1320, the model training controller 104A-E deploys a trained machine learning model to the target hardware platform.

At block 1320, the example model training controller 104A-E deploys the trained machine learning model to the target hardware platform. For example, the deployment controller 260 (FIG. 2) can deploy, distribute, and/or otherwise provide the best reward sparse model 506 to one or more target hardware platforms, such as the CPU 106, the first acceleration resource 108, etc., of FIG. 1. In such examples, the first acceleration resource 108 can execute and/or otherwise facilitate completion of one or more machine learning tasks, such as computer vision tasks, image processing tasks, etc., and/or a combination thereof. In some examples, the fine tuning handler 250 (FIG. 2) can complete the fine-tuning operation 402 of FIG. 4 on the best reward sparse model 506 of FIG. 5 to generate and/or otherwise output the final sparse model 406 of FIG. 4. After deploying the trained machine learning model to the target hardware platform at block 1320, the example machine readable instructions 1300 of FIG. 13 conclude.

FIG. 14 is a block diagram of an example processor platform 1400 structured to execute the instructions of FIGS. 12-13 to implement the example model training controller 104A-E of FIGS. 1 and/or 2. The processor platform 1400 can be, for example, a server, a personal computer, a workstation, a self-learning machine (e.g., a neural network), a mobile device (e.g., a cell phone, a smart phone, a tablet such as an iPad™), a gaming console, or any other type of computing device.

The processor platform 1400 of the illustrated example includes a processor 1412. The processor 1412 of the illustrated example is hardware. For example, the processor 1412 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 1412 implements the example configuration determiner 220, the example layer generator 230, the example model training handler 240, the example fine tuning handler 250, and the example deployment controller 260 of FIG. 2.

The processor 1412 of the illustrated example includes a local memory 1413 (e.g., a cache). The processor 1412 of the illustrated example is in communication with a main memory including a volatile memory 1414 and a non-volatile memory 1416 via a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1416 may be implemented by flash memory and/or any other desired type of memory device. Access to the main memory 1414, 1416 is controlled by a memory controller.

The processor platform 1400 of the illustrated example also includes an interface circuit 1420. The interface circuit 1420 may be implemented by any type of interface standard, such as an Ethernet interface, a universal serial bus (USB), a Bluetooth® interface, a near field communication (NFC) interface, and/or a PCI express interface. In this example, the interface circuit 1420 implements the communication interface 210 of FIG. 2.

In the illustrated example, one or more input devices 1422 are connected to the interface circuit 1420. The input device(s) 1422 permit(s) a user to enter data and/or commands into the processor 1412. The input device(s) can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuit 1420 of the illustrated example. The output devices 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer and/or speaker. The interface circuit 1420 of the illustrated example, thus, typically includes a graphics driver card, a graphics driver chip and/or a graphics driver processor.

The interface circuit 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, redundant array of independent disks (RAID) systems, and digital versatile disk (DVD) drives. In this example, the one or more mass storage devices 1428 implement the example datastore 270 to store the example hardware configuration(s) 272 (depicted as H/W CONFIG(S)), the example machine learning model 274 (depicted as ML MODEL), the example training data 276, and/or the example training output data 278 of FIG. 2.

Example machine executable instructions 1432 represented in FIGS. 12-13 may be stored in the mass storage device 1428, in the volatile memory 1414, in the non-volatile memory 1416, and/or on a removable non-transitory computer readable storage medium such as a CD or DVD.

The processor platform 1400 of the illustrated example of FIG. 14 includes an example graphic processing unit (GPU) 1440, an example vision processing unit (VPU) 1442, and an example neural network processor 1444. In this example, the GPU 1440, the VPU 1442, and the neural network processor 1444 are in communication with different hardware of the processing platform 1400, such as the volatile memory 1414, the non-volatile memory 1416, etc., via the bus 1418. In this example, the neural network processor 1444 can be implemented by one or more integrated circuits, logic circuits, microprocessors, GPUs, DSPs, or controllers from any desired family or manufacturer that can be used to execute an AI model, such as a neural network. In some examples, one or more of the configuration determiner 220, the layer generator 230, the model training handler 240, the fine tuning handler 250, and/or the deployment controller 260 can be implemented in or with at least one of the GPU 1440, the VPU 1442, or the neural network processor 1444 instead of or in addition to the processor 1412.

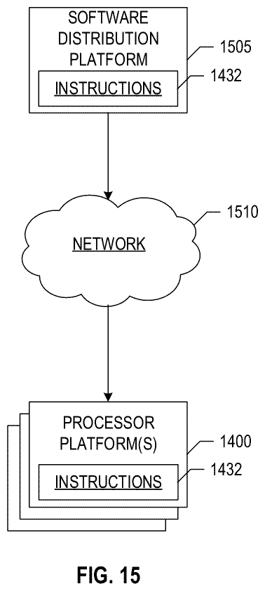

A block diagram illustrating an example software distribution platform 1505 to distribute software such as the example computer readable instructions 1432 of FIG. 14 to third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1432 of FIG. 14. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the computer readable instructions 1432, which may correspond to the example computer readable instructions 1200, 1300 of FIGS. 12-13, as described above. The one or more servers of the example software distribution platform 1505 are in communication with a network 1510, which may correspond to any one or more of the Internet and/or any of the example networks 128, 1426 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1432 from the software distribution platform 1505. For example, the software, which may correspond to the example computer readable instructions 1200, 1300 of FIGS. 12-13, may be downloaded to the example processor platform 1400, which is to execute the computer readable instructions 1432 to implement the model training controller 104A-E of FIGS. 1 and/or 2. In some example, one or more servers of the software distribution platform 1505 periodically offer, transmit, and/or force updates to the software (e.g., the example computer readable instructions 1432 of FIG. 14) to ensure improvements, patches, updates, etc. are distributed and applied to the software at the end user devices.

From the foregoing, it will be appreciated that example systems, methods, apparatus, and articles of manufacture have been disclosed that apply hardware-aware sparsity to a machine learning model, such as a neural network, which is guided and/or otherwise based on the hardware architecture of a target hardware platform. The disclosed methods, apparatus and articles of manufacture identify sparsity ratios for each layer of a neural network to be executed on the target hardware platform.

The disclosed methods, apparatus and articles of manufacture improve the efficiency of using a computing device by training and/or otherwise generating a machine learning model with relatively high performance on the computing device with substantially similar accuracy as a baseline version of the machine learning model, but with a reduced size (e.g., increased sparsity). Advantageously, the computing device can execute the machine learning model with a reduced number of cycles (e.g., clock cycles) compared to the baseline version. The disclosed methods, apparatus and articles of manufacture are accordingly directed to one or more improvement(s) in the functioning of a computer.

Example methods, apparatus, systems, and articles of manufacture for hardware-aware machine learning model training are disclosed herein. Further examples and combinations thereof include the following:

Example 1 includes an apparatus to train a machine learning model, the apparatus comprising a configuration determiner to determine a hardware configuration of a target hardware platform on which the machine learning model is to be executed, a layer generator to assign sparsity configurations to layers of the machine learning model based on the hardware configuration, and a deployment controller to deploy the machine learning model to the target hardware platform in response to outputs of the machine learning model satisfying respective thresholds, the outputs including a quantity of clock cycles to execute the machine learning model with the layers having the assigned sparsity configurations.

Example 2 includes the apparatus of example 1, wherein the layer generator is to select a first layer of the layers and assign a zero to one or more values of a matrix of the first layer, and further including a model training handler to determine a first quantity of clock cycles to execute a convolution operation with the matrix.

Example 3 includes the apparatus of example 1, wherein the outputs include an accuracy of the machine learning model, the respective thresholds are predetermined, the respective thresholds include an accuracy threshold and a clock cycle threshold, and further including a model training handler to determine whether the accuracy satisfies the accuracy threshold, and determine whether the quantity of the clock cycles satisfies the clock cycle threshold, and the deployment controller to retrain the machine learning model in response to at least one of (a) the accuracy not satisfying the accuracy threshold, or (b) the quantity of the clock cycles not satisfying the clock cycle threshold, and identify the machine learning model for deployment in response to (a) the accuracy satisfying the accuracy threshold, and (b) the quantity of the clock cycles satisfying the clock cycle threshold.

Example 4 includes the apparatus of example 1, wherein the hardware configuration includes at least one of memory configuration information, caching configuration information, or processing configuration information associated with the target hardware platform.

Example 5 includes the apparatus of example 1, wherein the hardware configuration specifies at least one of a cache size or a cache operating frequency associated with cache memory of the target hardware platform.

Example 6 includes the apparatus of example 1, wherein the hardware configuration specifies at least one of a memory type, a read memory bandwidth, a read bus width, a write memory bandwidth, a write bus width, a memory de-rate factor, or a number of memory ports associated with memory of the target hardware platform.

Example 7 includes the apparatus of example 1, wherein the hardware configuration specifies at least one of a number of data processing units, a clock frequency, a fabric frequency, an activation precision, or a weight precision associated with one or more processors of the target hardware platform.

Example 8 includes the apparatus of example 1, wherein the target hardware platform is a digital signal processor, a graphics processing unit, or a vision processing unit.

Example 9 includes an apparatus to train a machine learning model, the apparatus comprising means for determining a hardware configuration of a target hardware platform on which the machine learning model is to be executed, means for assigning sparsity configurations to layers of the machine learning model based on the hardware configuration, and means for deploying the machine learning model to the target hardware platform in response to outputs of the machine learning model satisfying respective thresholds, the outputs including a quantity of clock cycles to execute the machine learning model with the layers having the assigned sparsity configurations.

Example 10 includes the apparatus of example 9, wherein the means for determining is first means for determining, the means for assigning is to select a first layer of the layers and assign a zero to one or more values of a matrix of the first layer, and further including second means for determining a first quantity of clock cycles to execute a convolution operation with the matrix.

Example 11 includes the apparatus of example 9, wherein the means for determining is first means for determining, the outputs include an accuracy of the machine learning model, the respective thresholds are predetermined, the respective thresholds include an accuracy threshold and a clock cycle threshold, and further including second means for determining to determine whether the accuracy satisfies the accuracy threshold, and determine whether the quantity of the clock cycles satisfies the clock cycle threshold, and the means for deploying to retrain the machine learning model in response to at least one of (a) the accuracy not satisfying the accuracy threshold, or (b) the quantity of the clock cycles not satisfying the clock cycle threshold, and identify the machine learning model for deployment in response to (a) the accuracy satisfying the accuracy threshold, and (b) the quantity of the clock cycles satisfying the clock cycle threshold.

Example 12 includes the apparatus of example 9, wherein the hardware configuration includes at least one of memory configuration information, caching configuration information, or processing configuration information associated with the target hardware platform.

Example 13 includes the apparatus of example 9, wherein the hardware configuration specifies at least one of a cache size or a cache operating frequency associated with cache memory of the target hardware platform.

Example 14 includes the apparatus of example 9, wherein the hardware configuration specifies at least one of a memory type, a read memory bandwidth, a read bus width, a write memory bandwidth, a write bus width, a memory de-rate factor, or a number of memory ports associated with memory of the target hardware platform.

Example 15 includes the apparatus of example 9, wherein the hardware configuration specifies at least one of a number of data processing units, a clock frequency, a fabric frequency, an activation precision, or a weight precision associated with one or more processors of the target hardware platform.

Example 16 includes the apparatus of example 9, wherein the target hardware platform is a digital signal processor, a graphics processing unit, or a vision processing unit.

Example 17 includes a non-transitory computer readable storage medium comprising instructions that, when executed, cause a machine to at least determine a hardware configuration of a target hardware platform on which a machine learning model is to be executed, assign sparsity configurations to layers of the machine learning model based on the hardware configuration, and deploy the machine learning model to the target hardware platform in response to outputs of the machine learning model satisfying respective thresholds, the outputs including a quantity of clock cycles to execute the machine learning model with the layers having the assigned sparsity configurations.

Example 18 includes the non-transitory computer readable storage medium of example 17, wherein the instructions, when executed, cause the machine to select a first layer of the layers, assign a zero to one or more values of a matrix of the first layer, and determine a first quantity of clock cycles to execute a convolution operation with the matrix.

Example 19 includes the non-transitory computer readable storage medium of example 17, wherein the outputs include an accuracy of the machine learning model, the respective thresholds are predetermined, the respective thresholds include an accuracy threshold and a clock cycle threshold, and the instructions, when executed, cause the machine to determine whether the accuracy satisfies the accuracy threshold, determine whether the quantity of the clock cycles satisfies the clock cycle threshold, retrain the machine learning model in response to at least one of (a) the accuracy not satisfying the accuracy threshold, or (b) the quantity of the clock cycles not satisfying the clock cycle threshold, and identify the machine learning model for deployment in response to (a) the accuracy satisfying the accuracy threshold, and (b) the quantity of the clock cycles satisfying the clock cycle threshold.

Example 20 includes the non-transitory computer readable storage medium of example 17, wherein the hardware configuration includes at least one of memory configuration information, caching configuration information, or processing configuration information associated with the target hardware platform.

Example 21 includes the non-transitory computer readable storage medium of example 17, wherein the hardware configuration specifies at least one of a cache size or a cache operating frequency associated with cache memory of the target hardware platform.

Example 22 includes the non-transitory computer readable storage medium of example 17, wherein the hardware configuration specifies at least one of a memory type, a read memory bandwidth, a read bus width, a write memory bandwidth, a write bus width, a memory de-rate factor, or a number of memory ports associated with memory of the target hardware platform.

Example 23 includes the non-transitory computer readable storage medium of example 17, wherein the hardware configuration specifies at least one of a number of data processing units, a clock frequency, a fabric frequency, an activation precision, or a weight precision associated with one or more processors of the target hardware platform.

Example 24 includes the non-transitory computer readable storage medium of example 17, wherein the target hardware platform is a digital signal processor, a graphics processing unit, or a vision processing unit.

Example 25 includes a method to train a machine learning model, the method comprising determining a hardware configuration of a target hardware platform on which the machine learning model is to be executed, assigning sparsity configurations to layers of the machine learning model based on the hardware configuration, and deploying the machine learning model to the target hardware platform in response to outputs of the machine learning model satisfying respective thresholds, the outputs including a quantity of clock cycles to execute the machine learning model with the layers having the assigned sparsity configurations.

Example 26 includes the method of example 25, further including selecting a first layer of the layers, assigning a zero to one or more values of a matrix of the first layer, and determining a first quantity of clock cycles to execute a convolution operation with the matrix.

Example 27 includes the method of example 25, wherein the outputs include an accuracy of the machine learning model, the respective thresholds are predetermined, the respective thresholds include an accuracy threshold and a clock cycle threshold, and further including determining whether the accuracy satisfies the accuracy threshold, determining whether the quantity of the clock cycles satisfies the clock cycle threshold, retraining the machine learning model in response to at least one of (a) the accuracy not satisfying the accuracy threshold, or (b) the quantity of the clock cycles not satisfying the clock cycle threshold, and identifying the machine learning model for deployment in response to (a) the accuracy satisfying the accuracy threshold, and (b) the quantity of the clock cycles satisfying the clock cycle threshold.

Example 28 includes the method of example 25, wherein the hardware configuration includes at least one of memory configuration information, caching configuration information, or processing configuration information associated with the target hardware platform.

Example 29 includes the method of example 25, wherein the hardware configuration specifies at least one of a cache size or a cache operating frequency associated with cache memory of the target hardware platform.

Example 30 includes the method of example 25, wherein the hardware configuration specifies at least one of a memory type, a read memory bandwidth, a read bus width, a write memory bandwidth, a write bus width, a memory de-rate factor, or a number of memory ports associated with memory of the target hardware platform.

Example 31 includes the method of example 25, wherein the hardware configuration specifies at least one of a number of data processing units, a clock frequency, a fabric frequency, an activation precision, or a weight precision associated with one or more processors of the target hardware platform.

Example 32 includes the method of example 25, wherein the target hardware platform is a digital signal processor, a graphics processing unit, or a vision processing unit.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A method for generating an executable neural network, the method comprising:
providing an embedding state to a reinforcement learning agent, the embedding state representing one or more characteristics of a layer of a neural network;
generating, by the reinforcement learning agent based on the embedding state, one or more actions of reducing a number of computational cycles on a hardware device for executing the neural network;
invoking an execution of the neural network by the hardware device through the reduced number of computational cycles, the neural network generating an output;
determining a reward for the reinforcement learning agent by determining whether an accuracy of the output of the neural network reaches an accuracy threshold; and
updating a policy of the reinforcement learning agent based on the reward.

2. The method of claim 1, wherein the action comprises an action of pruning weights in the layer based on a sparsity ratio determined by the reinforcement learning agent.

3. The method of claim 1, further comprising:
providing one or more other embedding states of one or more other layers of the neural network to the reinforcement learning agent, p1 wherein the one or more actions are generated by the reinforcement learning agent further based on the one or more other embedding states, wherein the one or more actions comprise an action of pruning weights in the layer and one or more other actions of pruning weights in the one or more other layers.

4. The method of claim 1, wherein the one or more characteristics of the layer include an index, a kernel size, an input feature size, or a number of weights of the layer.

5. The method of claim 1, wherein the embedding state further represents an action of pruning weights in another layer of the neural network, wherein the another layer is precedent to the layer in the neural network.

6. The method of claim 1, wherein the reward is determined further by determining whether a target cycle reduction is reached by the one or more actions.

7. The method of claim 6, wherein the target cycle reduction is not reached by the one or more actions, wherein the reinforcement learning agent is to generate a new action using the updated policy, the new action comprising a reduction of computational cycles on the hardware device for executing one or more other layers in the neural network.

8. One or more non-transitory computer-readable media storing instructions executable to perform operations for generating an executable neural network, the operations comprising:
providing an embedding state to a reinforcement learning agent, the embedding state representing one or more characteristics of a layer of a neural network;
generating, by the reinforcement learning agent based on the embedding state, one or more actions of reducing a number of computational cycles on a hardware device for executing the neural network;
invoking an execution of the neural network by the hardware device through the reduced number of computational cycles, the neural network generating an output;
determining a reward for the reinforcement learning agent by determining whether an accuracy of the output of the neural network reaches an accuracy threshold; and
updating a policy of the reinforcement learning agent based on the reward.

9. The one or more non-transitory computer-readable media of claim 8, wherein the action comprises an action of pruning weights in the layer based on a sparsity ratio determined by the reinforcement learning agent.

10. The one or more non-transitory computer-readable media of claim 8, wherein the operations further comprise:
providing one or more other embedding states of one or more other layers of the neural network to the reinforcement learning agent,
wherein the one or more actions are generated by the reinforcement learning agent further based on the one or more other embedding states, wherein the one or more actions comprise an action of pruning weights in the layer and one or more other actions of pruning weights in the one or more other layers.

11. The one or more non-transitory computer-readable media of claim 8, wherein the one or more characteristics of the layer include an index, a kernel size, an input feature size, or a number of weights of the layer.

12. The one or more non-transitory computer-readable media of claim 8, wherein the embedding state further represents an action of pruning weights in another layer of the neural network, wherein the another layer is precedent to the layer in the neural network.

13. The one or more non-transitory computer-readable media of claim 8, wherein the reward is determined further by determining whether a target cycle reduction is reached by the one or more actions.

14. The one or more non-transitory computer-readable media of claim 13, wherein the target cycle reduction is not reached by the one or more actions, wherein the reinforcement learning agent is to generate a new action using the updated policy, the new action comprising a reduction of computational cycles on the hardware device for executing one or more other layers in the neural network.

15. An apparatus for generating an executable neural network, the apparatus comprising:
a computer processor for executing computer program instructions; and
a non-transitory computer-readable memory storing computer program instructions executable by the computer processor to perform operations comprising:
providing an embedding state to a reinforcement learning agent, the embedding state representing one or more characteristics of a layer of a neural network,
generating, by the reinforcement learning agent based on the embedding state, one or more actions of reducing a number of computational cycles on a hardware device for executing the neural network,
invoking an execution of the neural network by the hardware device through the reduced number of computational cycles, the neural network generating an output,
determining a reward for the reinforcement learning agent by determining whether an accuracy of the output of the neural network reaches an accuracy threshold, and
updating a policy of the reinforcement learning agent based on the reward.

16. The apparatus of claim 15, wherein the action comprises an action of pruning weights in the layer based on a sparsity ratio determined by the reinforcement learning agent.

17. The apparatus of claim 15, wherein the operations further comprise:
providing one or more other embedding states of one or more other layers of the neural network to the reinforcement learning agent,
wherein the one or more actions are generated by the reinforcement learning agent further based on the one or more other embedding states, wherein the one or more actions comprise an action of pruning weights in the layer and one or more other actions of pruning weights in the one or more other layers.

18. The apparatus of claim 15, wherein the embedding state further represents an action of pruning weights in another layer of the neural network, wherein the another layer is precedent to the layer in the neural network.

19. The apparatus of claim 15, wherein the reward is determined further by determining whether a target cycle reduction is reached by the one or more actions.

20. The apparatus of claim 15, wherein the target cycle reduction is not reached by the one or more actions, wherein the reinforcement learning agent is to generate a new action using the updated policy, the new action comprising a reduction of computational cycles on the hardware device for executing one or more other layers in the neural network.
